(19) United States
(12) Patent Application Publication
(10) Pub. No.: US 2014/0316805 A1
(43) Pub. Date: Oct. 23, 2014

(54) HEALTH MANAGEMENT METHOD

(71) Applicant: Panasonic Corporation, Osaka (JP)

(72) Inventor: Minehisa Nagata, Osaka (JP)

(21) Appl. No.: 14/360,400

(22) PCT Filed: Sep. 26, 2013
(86) PCT No.: PCT/JP2013/005725

§ 371 Date: May 23, 2014

Related U.S. Application Data
(60) Provisional application No. 61/707,056, filed on Sep. 28, 2012.

(51) Int. Cl. G06F 19/00

(52) U.S. Cl. CPC G06F 19/3418
USPC 705/2

(57) ABSTRACT

A health management method is used in a health management system that manages health of animals. The health management method includes the following steps. First, biological information of each of the animals is measured by a corresponding animal measurement terminal among measurement terminals to generate pieces of biological information of the animals. Then, the generated pieces of the biological information of the animals are obtained. Then, animal health information indicating a standard health condition of the animals is generated based on the obtained pieces of the biological information of the animals. Then, for each of the animals, the generated animal health information is compared to the biological information measured, thereby assessing a health condition of the animal. Then, a result of the assessing of the health condition of the animal is displayed on a display unit.

### TECHNICAL FIELD

The present invention relates to health management systems including measurement devices and health management methods of managing health condition of users, pets owned by the users, and the like.

### BACKGROUND ART

In conventional health management systems for pets, various sensors are attached to a subject pet to measure a body temperature, a heart rate, an amount of exercise, and the like, and results of the measurement are compared to health determination database in a home server to determine whether or not the subject pet is healthy (for example, see Patent Literature 1 (PLT 1)).

### CITATION LIST

### Patent Literature

[PTL 1] Japanese Unexamined Patent Application Publication No. 2006-42670

### SUMMARY OF INVENTION

### Technical Problem

However, the technique disclosed in PLT 1 has a problem of a low accuracy in determining whether or not a subject pet (animal) is healthy.

In order to address the above problem, an object of the present invention is to provide a health management method of determining, with a high accuracy, whether or not a subject animal is healthy.

### Solution to Problem

In accordance with an aspect of the present invention for achieving the object, there is provided a health management method used in a health management system that manages health of a plurality of animals, the health management method including: measuring biological information of each of the animals by a corresponding animal measurement terminal among a plurality of measurement terminals to generate pieces of biological information of the animals; obtaining the pieces of the biological information of the animals which are generated in the measuring; generating animal health information indicating a standard health condition of the animals, based on the pieces of the biological information of the animals which are obtained in the obtaining; comparing, for each of the animals, the animal health information generated in the generating of the animal health information to the biological information measured in the measuring, thereby assessing a health condition of the each of the animals; and displaying, on a display unit, a result of the assessing of the health condition of the each of the animals.

By the above method, animal health information is generated from pieces of biological information measured from a plurality of animals, and compared to biological information of a subject animal so as to assess health conditions of the subject animal. As a result, it is possible to assess the health conditions of the subject animal with a high accuracy.

It should be noted that the above general and specific aspect may be implemented to a system, a method, an integrated circuit, a computer program, or a computer-readable recording medium such as a Compact Disc-Read Only Memory (CD-ROM), or may be any combination of them.

### Advantageous Effects of Invention

The health management method according to the present embodiment is capable of determining, with a high accuracy, whether or not an animal is healthy.

### BRIEF DESCRIPTION OF DRAWINGS

FIG. 1 is a schematic diagram of a health management system according to Embodiment 1.

FIG. 2 is a block diagram illustrating a main structure of a measurement terminal according to Embodiment 1.

FIG. 3 is a block diagram illustrating a main structure of a measurement terminal according to Embodiment 1.

FIG. 4 is a block diagram illustrating a main structure of a health management server according to Embodiment 1.

FIG. 5 is a diagram illustrating an example of an ID management method according to Embodiment 1.

FIG. 6 is a flowchart of measurement performed by the measurement terminal according to Embodiment 1.

FIG. 7 is a flowchart of communication between the measurement terminal and the communication terminal according to Embodiment 1.

FIG. 8 is a flowchart of communication between the communication terminal and the health management server according to Embodiment 1.

FIG. 9 illustrates an example of a health information screen displayed on the communication terminal according to Embodiment 1.

FIG. 10 illustrates another example of a health information screen displayed on the communication terminal according to Embodiment 1.

FIG. 11 is a flowchart of updating standard health information according to Embodiment 1.

FIG. 12 is a block diagram illustrating a main structure of a microchip and the measurement terminal according to Embodiment 1.

FIG. 13 is a diagram illustrating an example of an ID management method using chip IDs according to Embodiment 1.

FIG. 14 is a diagram illustrating an example of an ID management method for substitution registration according to Embodiment 1.

FIG. 15 is a diagram illustrating an example of an ID management method using also veterinarian IDs according to Embodiment 1.

FIG. 16 is a diagram illustrating an example of an ID management method using also insurance provider IDs according to Embodiment 1.

FIG. 17 is a block diagram illustrating a structure of a health management server according to a variation of Embodiment 1.

FIG. 18 is a flowchart of a health management method according to Embodiment 1.

FIG. 19 is a schematic diagram of a health management system according to Embodiment 2.

FIG. 20 is a block diagram illustrating a main structure of a pet measurement terminal according to Embodiment 2.

FIG. 21 is a block diagram illustrating a main structure of a human measurement terminal according to Embodiment 2.

FIG. 22 is a block diagram illustrating a main structure of a communication terminal according to Embodiment 2.

FIG. 23 is a block diagram illustrating a main structure of a health management server according to Embodiment 2.

FIG. 24 is a diagram illustrating an example of an ID management method according to Embodiment 2.

FIG. 25 is a flowchart of generating recommendation information according to Embodiment 2.

FIG. 26 illustrates an example of a presented information screen displayed on the communication terminal according to Embodiment 2.

FIG. 27 illustrates another example of a presented information screen displayed on the communication terminal according to Embodiment 2.

FIG. 28 illustrates still another example of a presented information screen displayed on the communication terminal according to Embodiment 2.

FIG. 29 illustrates still another example of a presented information screen displayed on the communication terminal according to Embodiment 2.

FIG. 30 is a diagram illustrating a configuration of a conventional pet health management system.

### DESCRIPTION OF EMBODIMENTS

(Observation Based on which Present Invention is Conceived)

The inventors of the present invention found the following problems in the health management system disclosed in “Background Art”.

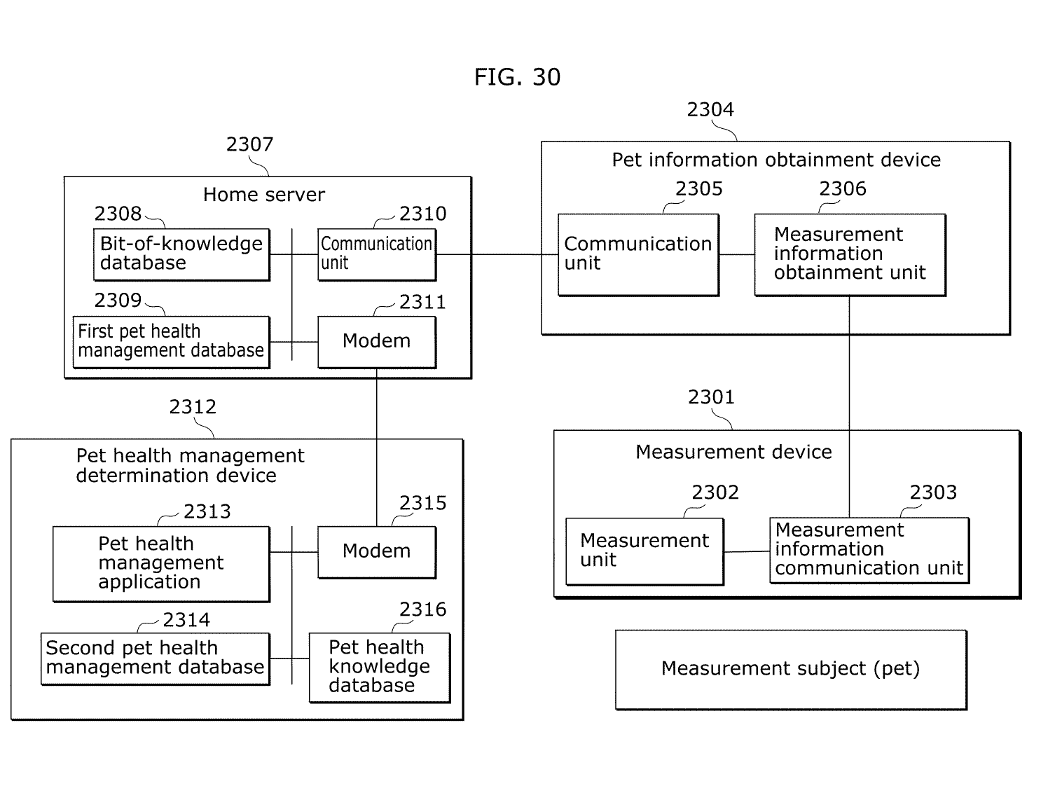

FIG. 30 schematically illustrates the conventional pet health management system disclosed in PLT 1.

Referring to FIG. 30, a measurement unit 2302 in a measurement device 2301 attached to a subject pet generates pet condition information that includes at least one of pieces of information indicating: a body temperature, a heart rate, a respiration rate, the number of steps, an amount of exercise, an activity range, a food amount, a stool output, mealtimes, a rehydration amount, rehydration times, a position, and smell of the subject pet. The pet condition information generated by the measurement unit 2302 is transmitted to a home server 2307 via a pet information obtainment device 2304 and then registered in a first pet health management database 2309. Furthermore, the pet condition information registered in the home server 2307 is transmitted to a pet health management determination device 2312 and registered in a second pet health management database 2314. Then, a pet health management application 2313 compares the pet condition information to pet health knowledge information stored in a pet health knowledge database 2316, in order to determine whether or not the subject pet is healthy.

However, the conventional configuration has the following problems. Since it is necessary to place the pet information obtainment device 2304, the home server 2307, and the like in home, it is difficult for a user outside the home and for a substitution taking care of the pet instead of the user to register the pet condition information into the pet health management determination device. Moreover, PLT 1 does not disclose a means for distinguishing a plurality of pets owned by a user. Therefore, there is a risk of registering wrong pet condition information. Furthermore, since the home server 2307 accumulates pieces of pet condition information of the same pet owned by a user, there is a risk that the pieces of pet condition information are biased. As a result, PLT 1 has a problem of a low accuracy in determining whether or not the pet (animal) is healthy.

In accordance with an aspect of the present invention for solving the above-described problems, there is provided a health management method used in a health management system that manages health of a plurality of animals, the health management method including: measuring biological information of each of the animals by a corresponding animal measurement terminal among a plurality of measurement terminals to generate pieces of biological information of the animals; obtaining the pieces of the biological information of the animals which are generated in the measuring; generating animal health information indicating a standard health condition of the animals, based on the pieces of the biological information of the animals which are obtained in the obtaining; comparing, for each of the animals, the animal health information generated in the generating of the animal health information to the biological information measured in the measuring, thereby assessing a health condition of the each of the animals; and displaying, on a display unit, a result of the assessing of the health condition of the each of the animals.

By the above method, the animal health information is generated from pieces of biological information measured from a plurality of animals, and compared to biological information of a subject animal to assess health condition of the subject animal. As a result, it is possible to assess the health condition of the subject animal with a high accuracy.

For example, it is possible that in the measuring, the corresponding animal measurement terminal measures the biological information of the each of the animals at predetermined timing, and the health management method further includes updating the animal health information generated in the generating of the animal health information, based on a latest piece of biological information among the pieces of the biological information of the animals which are generated in the measuring.

By the above method, the animal health information is updated based on the latest biological information. As a result, it is possible to assess health condition of a subject animal with a high accuracy.

For example, it is also possible that the measuring further includes measuring human biological information of each of people by a corresponding human measurement terminal among the plurality of the measurement terminals to generate pieces of human biological information of the people, the obtaining further includes obtaining the pieces of the human biological information of the people which are generated in the measuring, the generating of the animal health information further includes generating human health information indicating a standard health condition of the people based on the pieces of the human biological information of the people which are generated in the measuring of the human biological information, the comparing further includes comparing, for each of the people, the human health information generated in the generating of the human health information to the human biological information measured in the measuring of the human biological information, thereby assessing a health condition of the each of the people, and the displaying further includes displaying, on the display unit, a result of the assessing of the health condition of the each of the people.

By the above method, besides the animal health information, the human health information is generated from pieces of biological information measured from people, and compared to biological information of a subject person to assess health condition of the subject person. As a result, it is possible to assess health condition of the subject person with a high accuracy.

For example, it is further possible that the health management method further includes generating recommendation information based on the biological information of the each of the animals and the human biological information of the each of the people which are measured in the measuring, and presenting the recommendation information to the each of the people, the recommendation information being generated to improve the health condition of the each of the animals and the health condition of the each of the people.

By the above method, the recommendation information is presented to a subject person to improve health conditions of a subject animal and the subject person. As a result, the subject animal and the subject person can perform activity together based on the recommendation information.

For example, it is still further possible that the health management method further includes calculating an activity amount of the each of the animals from the biological information of the each of the animals as measured in the measuring, and calculating an activity amount of the each of the people from the biological information of the each of the people as measured in the measuring, wherein, in the generating of the recommendation information, a walking route is generated as the recommendation information and presented to the each of the people, the walking route having a distance corresponding to the activity amount of the each of the animals and the activity amount of the each of the people.

By the above method, a distance of a walking route is changed to an appropriate distance according to, for example, an activity amount of a current day. As a result, a user can easily perform exercise that results in appropriate activity amounts of the user and an animal owned by the user.

For example, it is still further possible that the measuring further includes measuring, by the corresponding animal measurement terminal, a position of the each of the animals at a time of the measuring of the biological information of the each of the animals, thereby generating position information indicating the position, the obtaining further includes obtaining the position information indicating the position of the each of the animals as generated in the measuring, the health management method further includes determining, based on the biological information of the each of the animals as measured in the measuring, whether or not the each of the animals is happy at the position indicated in the position information, and in the generating of the recommendation information, when it is determined that the each of the animals is happy at the position, a walking route including the position is generated based on the position information and presented as the recommendation information to the each of the people.

By the above method, a walking route including a position where the subject animal has been happy is recommended. As a result, it is possible to easily walk on a walking route corresponding to preference of the subject animal.

For example, it is still further possible that, in the generating of the human health information, pieces of the human health information are classified into a plurality of items according to at least one of an age and a sex of the people, and in the comparing, a piece of the human health information classified into an item corresponding to the each of the people among the items is compared to the human biological information of the each of the people as measured in the measuring, thereby assessing the health condition of the each of the people. For example, it is still further possible that in the generating of the animal health information, pieces of the animal health information are classified into a plurality of items according to at least one of a breed, an age, and a sex of the animals, and in the comparing, a piece of the animal health information classified into an item corresponding to the each of the animals among the items is compared to the animal biological information of the each of the animals as measured in the measuring, thereby assessing the health condition of the each of the animals.

By the above method, pieces of information of standard health conditions are generated for respective different types of animals or people. It is therefore possible to determine health conditions appropriate to a type of a subject animal or person. As a result, it is possible to determine, with a high accuracy, whether or not the subject animal or person is healthy.

It should be noted that the above general and specific aspect may be implemented to a system, a method, an integrated circuit, a computer program, or a computer-readable recording medium such as a CD-ROM, or may be any combination of them.

The following describes embodiments of the present invention in detail with reference to the Drawings.

It should be noted that all the embodiments described below are specific examples of the present invention. Numerical values, shapes, materials, structural elements, arrangement positions and the connection relationships of the structural elements, steps, the order of the steps, and the like described in the following embodiments are merely examples, and are not intended to limit the present invention. Moreover, among the structural elements in the following embodiments, structural elements that are not described in independent claims that show the most generic concept of the present invention are described as elements constituting more desirable configurations.

### Embodiment 1

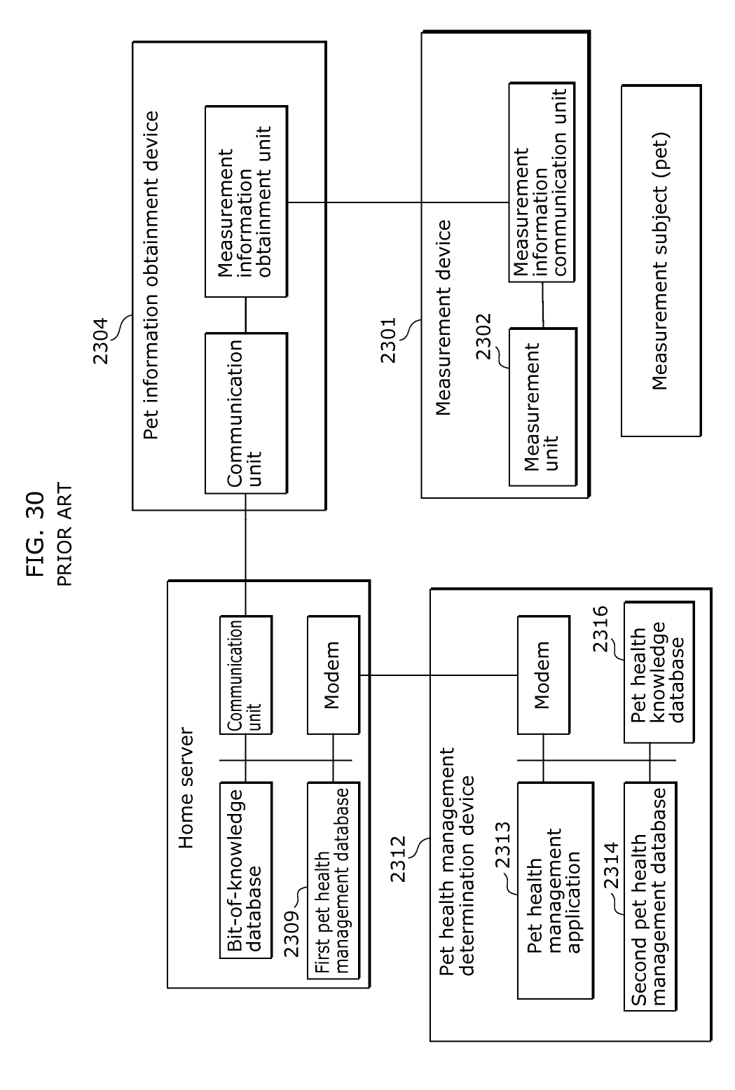

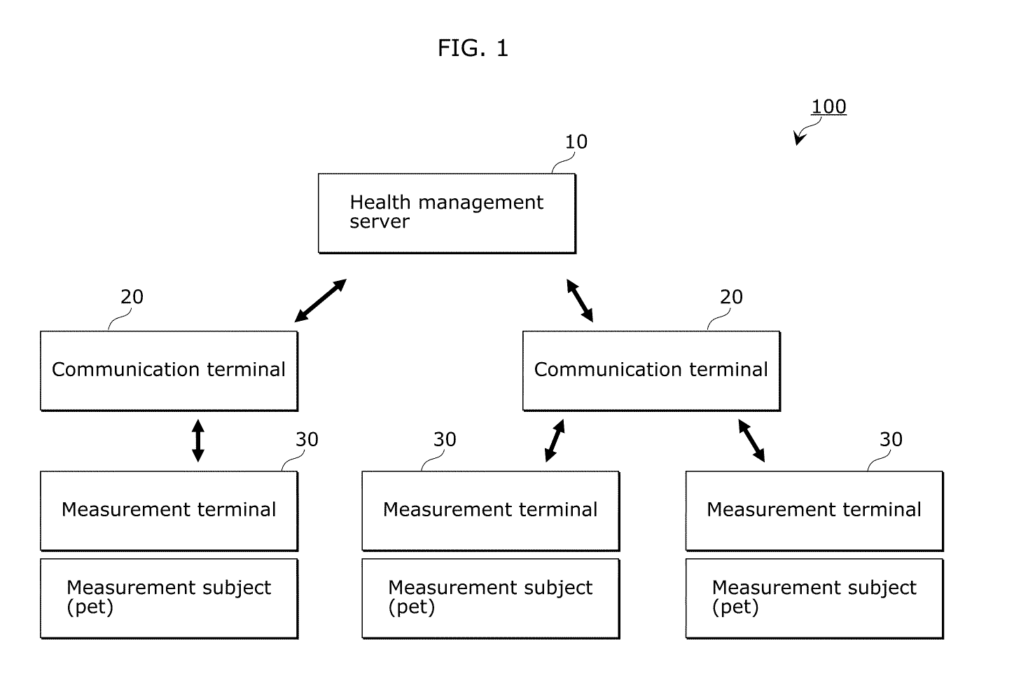

FIG. 1 is a block diagram illustrating a main part of a health management system according to Embodiment 1 of the present invention.

### Configuration of Health Management System

As illustrated in FIG. 1, the health management system 100 according to the present embodiment includes a plurality of measurement terminals 30, a plurality of communication terminals 20, and a health management server 10. Each of the measurement terminals 30 generates, as measurement information, biological information and/or a behavior history of a pet (animal) that is a measurement subject (hereinafter, referred to also as a “subject pet” or a “subject animal”), and transmits the generated measurement information to a corresponding one of the communication terminals 20. Each of the communication terminals 20 transmits such measurement information received from a corresponding one of the measurement terminals 30 to the health management server 10 via the Internet. The health management server 10 assesses, for each of such subject pets, health conditions based on the pieces of measurement information received from the communication terminals 20, and notify each of the communication terminals 20 of health information indicating the assessed health conditions of the corresponding subject pet.

The respective structural elements are described in more detail.

### Measurement Terminal

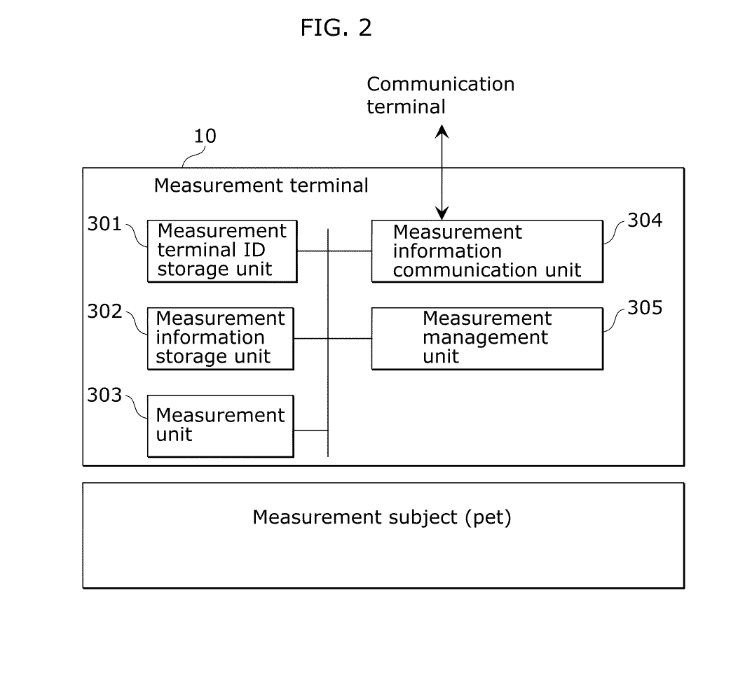

FIG. 2 is a block diagram illustrating a main structure of the measurement terminal 30.

As illustrated in FIG. 2, each of the measurement terminals 30 includes a measurement terminal ID storage unit 301, a measurement unit 303, a measurement information storage unit 302, a measurement information communication unit 304, and a measurement management unit 305.

The measurement terminal ID storage unit 301 stores a measurement terminal ID for identifying the corresponding measurement terminal 30. The measurement unit 303 measures biological information and/or a behavior history of a subject pet to generate measurement information. The measurement information storage unit 302 stores the measurement information generated by the measurement unit 303. The measurement information communication unit 304 communicates with a corresponding one of the communication terminals 20 to transmit the measurement information stored in the measurement information storage unit 302 to the communication terminal 20. The measurement management unit 305 manages timing of measuring the biological information and/or the behavior history of the pet by the measurement unit 303. The measurement management unit 305 may include, as needed, a timer unit (not illustrated) that timing for the measurement of the measurement management unit 305.

The measurement unit 303 measures, as measurement information, at least one of pieces of biological information indicating a body temperature, a heart rate, a respiration rate, a weight, the number of steps, an activity amount, a position, cry, smell, brain waves, action of a specific physical part (for example, movements of a tail or a neck), blood constituent, body hair constituent, and the like. Although FIG. 2 illustrates a single measurement unit 303, it is also possible to provide a plurality of the measurement units 303 to a single measurement terminal 30 according to kinds of generated pieces of information, or provide a plurality of the measurement terminals 30 to a single pet. It is further possible that a group of the measurement terminals 30 form a measurement means for a plurality of pets. More specifically, the measurement terminals 30 in a group are attached to pets, so that each of the pets wears at least one of the measurement terminals 30. In other words, in order to measure the plurality of pets, a corresponding one of the measurement terminals 30 which is attached to each of the pets measures biological information of the corresponding animal (pet).

The measurement timing managed by the measurement management unit 305 may be determined as at least one of: when instructions are received from the corresponding communication terminal 20 or the health management server 10; always; at a predetermined time; with predetermined time intervals; and when a subject pet moves to a predetermined place. In other words, biological information of each of pets is measured at corresponding predetermined timing by a corresponding one of the measurement terminals 30.

Furthermore, regarding the measurement timing managed by the measurement management unit 305, it is possible that an other kind of measurement information is measured when a certain kind of measurement information is generated by the measurement unit 303, or that an other kind of measurement information is measured when a certain kind of measurement information exceeds a threshold. It is further possible that the measurement information communication unit 304 in the measurement terminal 30 receives a determination algorism for the measurement timing from the corresponding communication terminal 20 or the health management server 10, and the measurement is timed according to the determination algorism.

The measurement information communication unit 304 is capable of performing: wired connection communications, such as a Universal Serial Bus (USB) and Ethernet®; wireless connection communications, such as a wireless Local Area Network (LAN), Bluetooth®; telephone line communications, such as third-generation cell-phone (3G) and Long Term Evolution (LTE); contact communications used in Integrated Circuit (IC) cards, Smartphones, and the like; non-contact communications; Near-Field Communication (NFC); and the like. The communication method of the measurement information communication unit 304 is not limited. The measurement information communication unit 304 provides the corresponding communication terminal 20 with at least the measurement terminal ID stored in the measurement terminal ID storage unit 301 and the measurement information stored in the measurement information storage unit 302.

The measurement terminal 30 may be in a variety of forms to be used on or close to a subject pet. For example, the measurement terminal 30 may be a used as a collar, attached to a collar, attached to a part of a pet body, such as a head, an ear, a tail, a back, or a leg, or embedded in the pet body. However, the form of the measurement terminal 30 is not limited to the above examples. It is also possible that the measurement terminal 30 is provided to a place or a device which a subject pet frequently uses.

### Communication Terminal

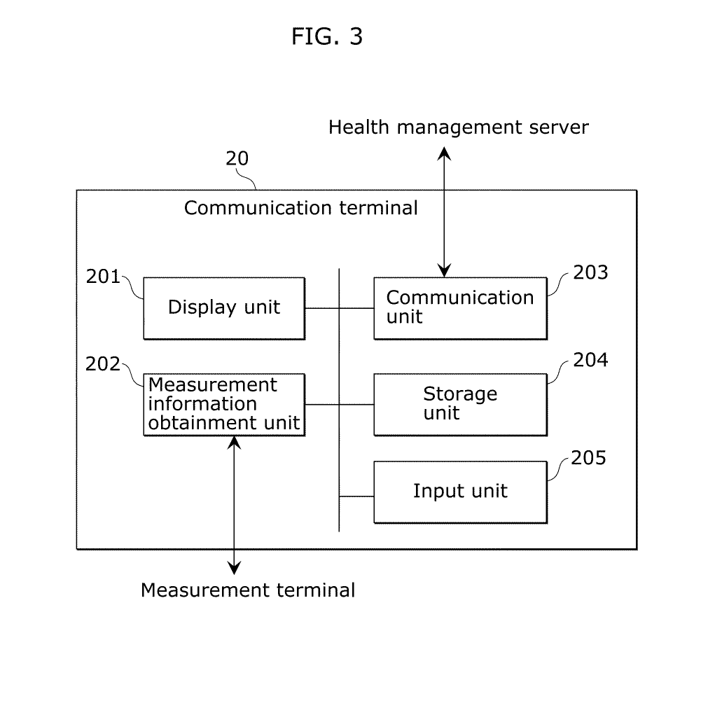

FIG. 3 is a block diagram illustrating a main structure of the measurement terminal 20.

As illustrated in FIG. 3, each of the communication terminals 20 includes a measurement information obtainment unit 202, a communication unit 203, a storage unit 204, an input unit 205, and a display unit 201.

The measurement information obtainment unit 202 receives measurement information and the like from a corresponding one of the measurement terminals 30. The communication unit 203 communicates with the health management server 10 to exchange various pieces of information with the health management server 10. The various pieces of information include the measurement information received by the measurement information obtainment unit 202, health information (described later), and the like. The storage unit 204 stores a user ID issued from the health management server 10, the measurement information, the health information, and the like. The input unit 205 receives information regarding the subject pet, an owner of the subject pet, and the like. The display unit 201 displays the measurement information, the health information, and the like. The display unit 201 may display assessment results (described later) of the health conditions of the subject pet. The communication terminals 20 may further include an image capturing unit not illustrated.

The communication terminal 20 is desirably a terminal which a user daily uses, such as a mobile phone or a Smartphone. However, the communication terminal 20 may be a terminal dedicated to data exchange between the corresponding measurement terminal 30 and the health management server 10. The communication terminal 20 may be provided to a place or a device which the subject pet frequently uses.

The measurement information obtainment unit 202 may use any method corresponding to the communication method of the measurement information communication unit 304 in the corresponding measurement terminal 30. Although the previously-described communication methods may be used, the method used by the measurement information obtainment unit 202 is not limited to these methods.

The communication unit 203 transmits, to the health management server 10, the user ID as well as the measurement terminal ID and the measurement information which are stored in the storage unit.

In other words, for a plurality of pets, a corresponding one of the communication terminals 20, which corresponds to a measurement terminal (animal measurement terminal) of each of the pets, obtains biological information of the corresponding animal (pet) which is generated by the corresponding measurement terminal. Then, the corresponding communication terminal transmits the obtained biological information of the pet to the health management server 10.

### Health Management Server

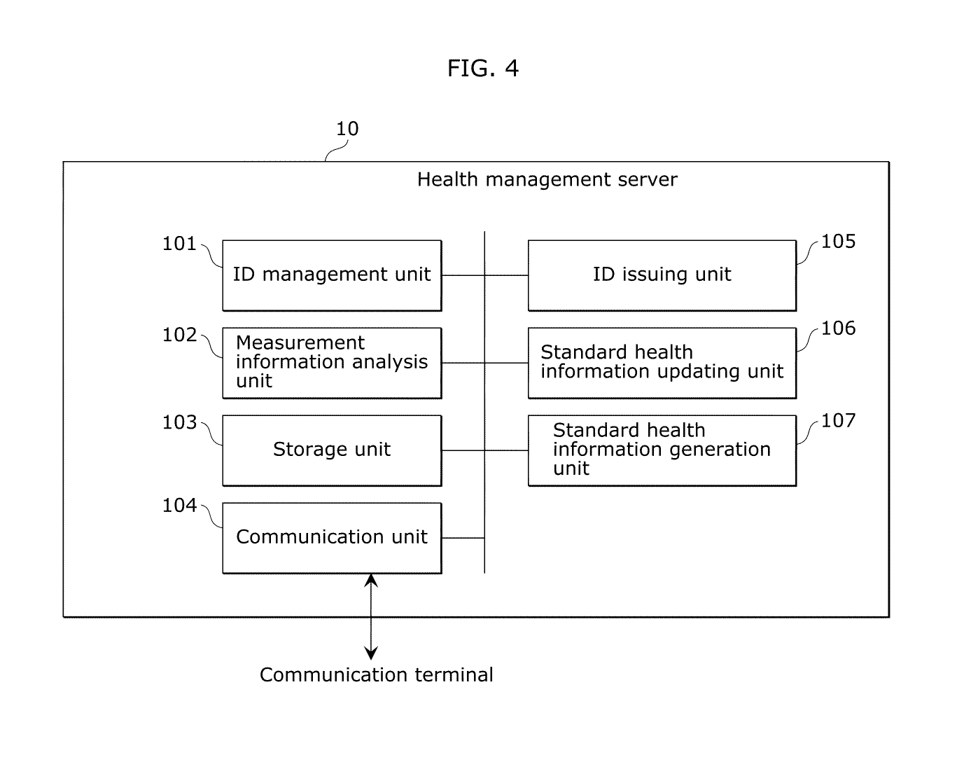

FIG. 4 is a block diagram illustrating a main structure of the health management server 10.

As illustrated in FIG. 4, the health management server 10 includes a communication unit 104, an ID issuing unit 105, an ID management unit 101, a storage unit 103, a standard health information generation unit 107, a measurement information analysis unit 102, and a standard health information updating unit 106.

The communication unit 104 receives a measurement terminal ID, measurement information, a user ID, and the like from each of the communication terminals 20, and transmits health information and the like to each of the communication terminals 20.

The ID issuing unit 105 issues a user ID to a user who requests for use of the health management server 10.

The ID management unit 101 manages a relationship between the user ID and a corresponding one of the measurement terminals ID.

The storage unit 103 stores (accumulates) pieces of measurement information received by the communication unit 104, for each pet (in other words, for each pet ID described later). The storage unit 103 stores animal health information (described later) generated by the standard health information generation unit 107.

The standard health information generation unit 107 generates animal health information that is used as criteria on which health conditions of pets are assessed. In other words, the standard health information generation unit 107 obtains pieces of the measurement information indicating respective pieces of biological information of respective pets from the respective communication terminals. Then, based on the obtained pieces of measurement information regarding the respective pets, the standard health information generation unit 107 generates animal health information (pet standard health information) indicating standard health information that is standard for the plurality of animals (pets).

The measurement information analysis unit 102 analyzes measurement information of each pet based on the animal health information generated by the standard health information generation unit 107, and thereby generates, as a result of the analysis, health information indicating health conditions of the pet. More specifically, the measurement information analysis unit 102 compares, for each of pets, measurement information stored in the storage unit 103 to the pet standard health information (namely, the health information) generated by the standard health information generation unit 107, thereby assessing health conditions of the pet. As a result, the measurement information analysis unit 102 generates an assessment result of the health conditions of the pet.

The standard health information updating unit 106 updates the standard health information generated by the standard health information generation unit 107, based on measurement information stored in the storage unit 103. More specifically, the standard health information updating unit 106 updates the animal health information generated by the standard health information generation unit 107, based on the latest measurement information among the pieces of measurement information generated by the respective measurement terminals 30 for a plurality of pets.

It should be noted that, if determination algorisms each of which is used to determine when a corresponding one of the measurement terminal 30 transmits measures biological information for a pet are transmitted from the health management server 10, the health management server 10 may further include a measurement timing generation unit. In this case, the measurement timing generation unit generates each of the determination algorisms for measuring timing, based on corresponding measurement information, the standard health information, and the like, and transmits the generated determination algorism to the corresponding measurement terminal 30.

It should also be noted that the “animal health information” is information indicating standard health conditions of pets and used as criteria for assessing health conditions of a subject pet. For example, the animal health information includes pieces of biological information to be used as health indicators. For example, in the case of dogs, the biological information included in the animal health information may indicate that a body temperature in a normal state is 38.6 to 39.2 degrees for small dogs and 37.5 to 38.6 degrees for large dogs, that a pulse rate is 60 to 120 per minute for small dogs and 60 to 80 per minute for large dogs, and that a respiration rate is 20 to 30 per minute for small dogs and 10 to 15 per minute for large dogs. Furthermore, in addition to the information regarding the normal state, the animal health information may further include information indicating a correlation between biological information and emotion information. For example, the animal health information includes information indicating a correlation between biological information and emotion information such as tension, excitement, delight, anger, sorrow, and pleasure, or information indicating a correlation between biological information and a crying pattern. In addition, the animal health information may include information indicating diseases and signs of the diseases. The animal health information may include information specific to each breed. For example, the animal health information may include information indicating that dachshunds are susceptible to hernia. Moreover, in the animal health information, it is possible to manage the biological information and emotion information in association with breed, pedigree, age, sex, weight, region, position information, season, weather, time zone, and the like regarding pets.

More specifically, the standard health information generation unit 107 may generate the animal health information having pieces of information which are classified into one or more items, such as a breed, a pedigree, an age, a sex, a weight, a region, position information, a season, weather, a time zone, and the like of pets. In this case, for each of pets, the measurement information analysis unit 102 compares (a) measurement information of a subject pet which is stored in the storage unit 103 to (b) the information classified into an item corresponding to the subject pet among the pieces of information included in the animal health information generated by the standard health information generation unit 107, thereby assessing health conditions of the subject pet.

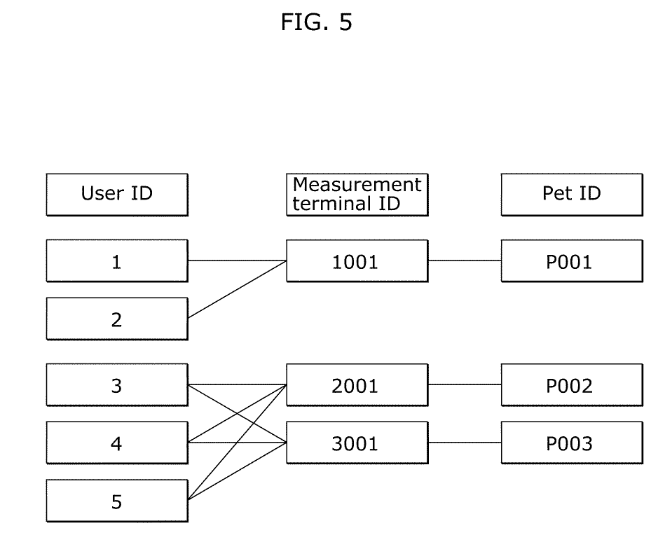

FIG. 5 is a diagram illustrating an example of management of user IDs and measurement terminal IDs in the ID management unit 101.

In the example of FIG. 5, a measurement terminal ID=“1001” is associated with a user ID=“1” and a user ID=“2”. Therefore, only a user using the user ID=“1” and a user using the user ID=“2” are allowed to refer to or register measurement information and health information which are unique to the measurement terminal ID=“1001”. Likewise, each of a measurement terminal ID=“2001” and a measurement terminal ID=“3001” is associated with a user ID=“3”, a user ID=“4”, and a user ID=“5”. Therefore, only a user using the user ID=“3”, a user using the user ID=“4”, and a user using the user ID=“5” are allowed to refer to or register measurement information and health information which are unique to the measurement terminal ID=“2001” and measurement information and health information which are unique to the measurement terminal ID=“3001”.

Each of the users ID is an ID used to identify a corresponding user who uses the health management server 10. Such a user ID is managed by the ID management unit 101 as user information in association with a contact address, an email address, a name, a nickname, and the like of a corresponding user. Therefore, the user information is stored in the ID management unit 101.

Each of pet IDs is an ID managed in the health management server 10. Each of pet IDs is used to identify a corresponding pet. When a user registers, in the health management server 10, information of a newly-owned pet, such as a breed, a pedigree, a birthday, a sex, a name, and the like of the pet, the ID issuing unit 105 issues a pet ID for the pet, and manages a relationship between the pet ID and a measurement terminal ID of a measurement terminal 30 used for the pet. Assuming that a measurement terminal 30 used for a subject pet may be broken and that a plurality of measurement terminals 30 may be used by a plurality of users for a single pet, it is possible to associate a single pet ID with a plurality of measurement terminal IDs (1-to-N relationship). Since a single pet ID is issued for a single pet, (a) measurement information received together with a measurement terminal ID and (b) health information of the pet are managed in association with the pet ID. It should be noted that, as illustrated in FIG. 5, user information may be a set of a user ID, measurement terminal ID(s), and pet ID(s) which are associated with one another. Apart from the user information, the ID management unit 101 may manage (store) pet information that is a set of a pet ID and measurement terminal ID(s) which are associated with each other.

### Measurement

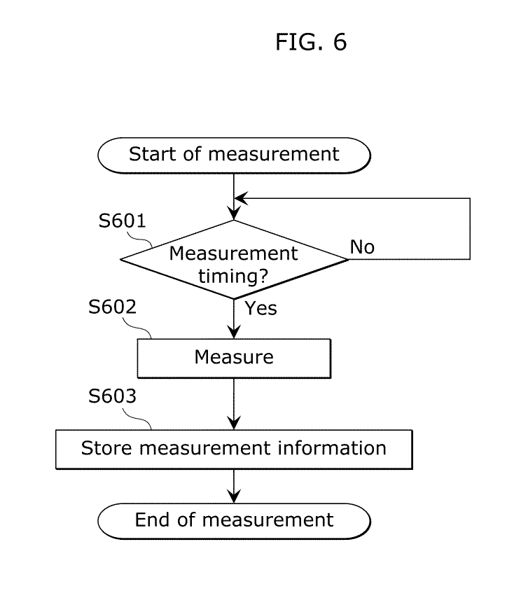

The following describes measurement performed by each of the measurement terminals 30 with reference to a flowchart of FIG. 6.

First, the measurement management unit 305 determines whether or not it is measurement timing (in other words, whether or not to start measurement), and if it is determined that it is measurement timing, the processing proceeds to Step S602 (Step S601).

The measurement timing has been described previously.

Next, the measurement management unit 305 instructs the measurement unit 303 to perform measurement, therefore the measurement unit 303 generates biological information, a behavior history, and the like of a measurement subject as measurement information, and the processing proceeds to Step S603 (Step S602).

The measurement information storage unit 302 stores the generated measurement information, and the processing is completed (Step S603).

By the above-described processing, the measurement terminal 30 stores the measurement information of the measurement subject.

### Transmission of Measurement Information

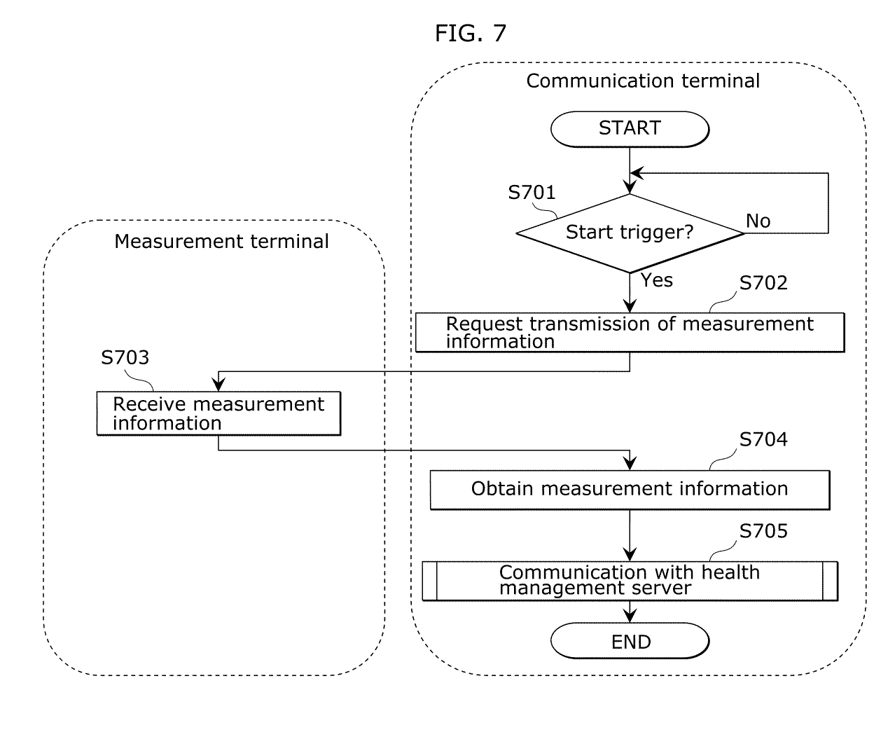

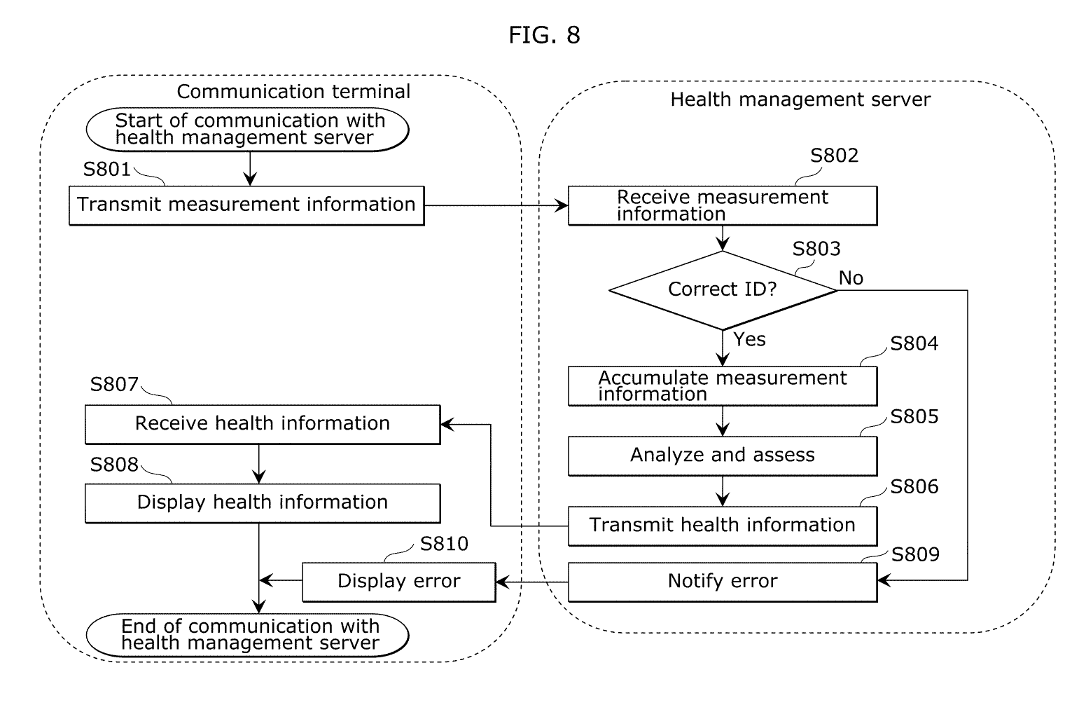

Next, the description is given for transmission of measurement information from a measurement terminal 30 to the health management server 10 via a communication terminals 20 (hereinafter, referred to as “measurement information transmission”) with reference to flowcharts of FIGS. 7 and 8.

First, a target communication terminal 20 determines whether or not to start measurement information transmission, and if it is determined that the measurement information transmission is to start, the processing proceeds to Step S702 (Step S701).

The method of the determination may be any one of the following methods, but the method is not limited to these methods and may be any other method.

The measurement information transmission at Step S701 may be started: when the communication terminal 20 is activated; when a user instructs the start by using the input unit 205; when it is determined that the communication terminal 20 and a corresponding measurement terminal 30 are connected to the same LAN; when the communication terminal 20 is brought to a position within a certain distance from the measurement terminal 30; when the communication terminal 20 and the measurement terminal 30 are brought closer to each other to be capable of communicating each other; at a predetermined time; when a predetermined time period has passed since previous transmission; and the like.

If it is determined at Step S701 that the measurement information transmission is to start, then the measurement information obtainment unit 202 in the communication terminal 20 requests the measurement information communication unit 304 in a measurement terminal 30 associated with the communication terminal 20 to transmit measurement information (Step S702).

Next, the measurement information communication unit 304 transmits a measurement terminal ID and the measurement information to the measurement information obtainment unit 202 in the communication terminal 20 (Step S703).

Next, the measurement terminal ID and the measurement information which are received by the measurement information obtainment unit 202 are stored into the storage unit 204 (Step S704).

Next, health management server communication is performed by transmitting the measurement information stored in the storage unit 204 from the communication unit 203 in the communication terminal 20 to the health management server 10, thereby completing the measurement information transmission (Step S705).

FIG. 8 is a flowchart of detailed steps in the health management server communication at Step S705.

First, the communication unit 203 in the communication terminal 20 transmits, to the health management server 10, a user ID and the measurement terminal ID and measurement information which are stored at Step S704 (Step S801).

Then, the communication unit 104 in the health management server 10 receives the user ID, the measurement terminal ID, and the measurement information (Step S802).

Next, if a combination of the received user ID and the received measurement terminal ID matches one of combinations managed in the ID management unit 101, then the processing proceeds to Step S804, and otherwise, the processing proceeds to Step S809 (Step S803).

If it is determined at Step S803 that the combination of the user ID and the measurement terminal ID is correct, the measurement information is stored in the storage unit 103 (Step S804).

Next, the measurement information analysis unit 102 compares the measurement information to the standard health information (namely, the animal health information) generated by the standard health information generation unit 107, thereby generates health information as a result of assessing health conditions of a pet having a pet ID associated with the measurement terminal ID, and stores the health information into the storage unit 103 (Step S805).

Next, the communication unit 104 transmits the health information generated by the measurement information analysis unit 102 to the communication unit 203 in the communication terminal 20 (Step S806).

Then, the communication unit 203 receives the health information from the communication unit 104, and stores the health information into the storage unit 204 (Step S807).

Next, the display unit 201 displays the health information stored in the storage unit 204, and the processing is completed (Step S808).

On the other hand, if it is determined at Step S803 that the combination between the user ID and the measurement terminal ID is not correct, then the communication unit 104 in the health management server 10 notifies the error to the communication unit 203 in the communication terminal 20 (Step S809).

Next, the display unit 201 displays the error, and the processing is completed (Step S810).

The following describes the analysis method at Step S805 performed by the measurement information analysis unit 102. However, the method used by the measurement information analysis unit 102 is not limited to the method. Any method is possible as long as health information is generated based on measurement information and standard health information.

First, the standard health information generation unit 107 generates standard health information as criteria used in comparison with measurement information, based on any one of pieces of information described below or any combination of the pieces of information.

More specifically, the standard health information used in the analysis of the measurement information analysis unit 102 may include a breed, a pedigree, and an age calculated from a birthday of a pet registered with a pet ID associated with a measurement terminal ID. The standard health information may include the latest weight included in the measurement information stored in the storage unit 103. The standard health information may include position information included in the latest measurement information, and region information obtained based on the position information. The standard health information may include a season and a time zone when the measurement information is measured. The standard health information may include weather when the measurement information is measured.

Next, the measurement information analysis unit 102 analyses the measurement information based on the standard health information as described above by using any one of the following methods or a combination of the methods, thereby generating health information.

The measurement information analysis unit 102 may generate health information indicating whether or not a value of biological information or a behavior history included in the measurement information is within a normal range of the standard health information. The measurement information analysis unit 102 may compare a value of past measurement information of a subject pet to a value of the latest measurement information, and thereby generate health information indicating whether or not a difference between the values is within a predetermined threshold range. The measurement information analysis unit 102 may compare a difference of measurement information in a predetermined time period to a difference of the standard health information in the predetermined time period, and thereby generate health information indicating whether or not the difference of measurement information is a sign that appears immediately before disease. If the measurement information includes a crying pattern, the measurement information analysis unit 102 may speculate health condition from the crying pattern to generate health information. The measurement information analysis unit 102 may speculate emotion from a value of the measurement information, thereby generating health information. The measurement information analysis unit 102 may associate position information of the measurement information with the speculated emotion to generate health information indicating a place where the pet is happy or not happy inside and outside home.

As a result, it is possible to register the measurement information generated by the measurement terminals 30 into the health management server 10. Furthermore, the health management server 10 is capable of generating health information and transmitting the health information to the communication terminals 20, and the user can obtain the health information of the pet by the communication terminal 20 and checks the health information.

It should be noted that the measurement information stored in the measurement information storage unit 302 in the measurement terminal 30 may be deleted after having been transmitted. In this case, the communication terminal 20 may instruct the deletion of the measurement information from the measurement terminal 30, when the measurement information is stored in the communication terminal 20. In this case, the measurement terminal 30 deletes the measurement information from the measurement information storage unit 302, after receiving the instructions.

Furthermore, although it has been described that, at Step S809, an error is notified to the communication terminal 20 that has transmitted the measurement information, the present invention is not limited to the above. It is also possible to notify an error to a contact address or an email address of a user having a user ID managed and associated with a measurement terminal ID of the measurement terminal 30.

Furthermore, it is possible to eliminate Step S803 and store the measurement information regardless of whether or not the user ID is correct.

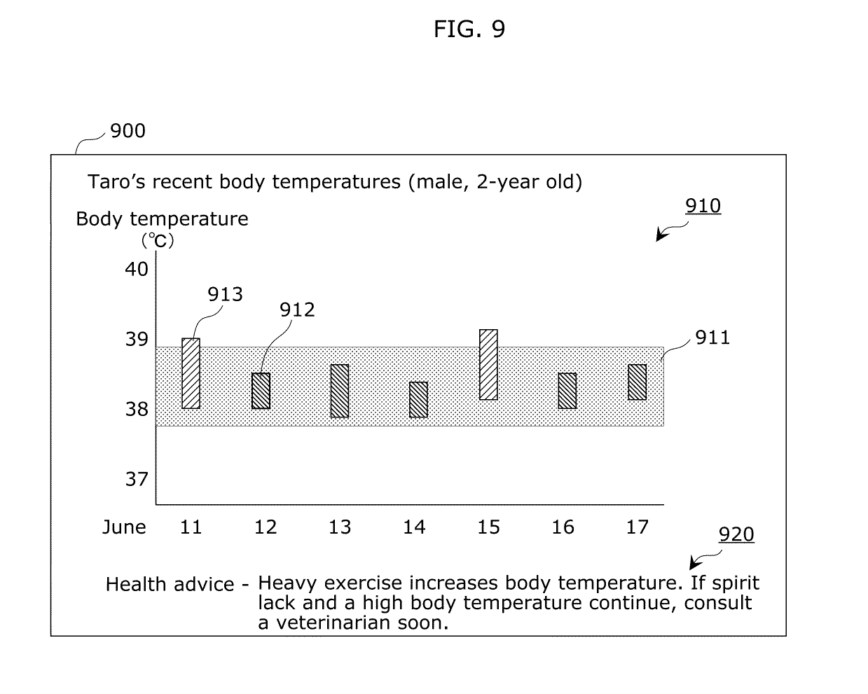

FIG. 9 is an example of a health info ion screen 900 displayed on the communication terminal 20.

As illustrated in FIG. 9, on the health information screen 900, there are displayed a graph 910 showing body temperatures of a pet, Taro, on the last seven days, and a health advice (message) 920 related to the body temperatures. In the graph 910, a vertical axis indicates a body temperature, and a horizontal axis indicates a date. The graph 910 shows a normal body temperature range 911 and bars 912 and 913. The normal body temperature range 911 is a range of normal body temperatures derived from information classified to the item corresponding to Taro (namely, a subject pet) among the standard health information. Each of the bars 912 and 913 shows a width from the highest body temperature and the lowest body temperature in a day. Among the bars 912 and 913, the bar 912 having body temperatures all of which are within the normal body temperature range 911 and the bar 913 including a body temperature exceeding the normal body temperature range 911 are displayed as different kinds of bars. Regarding the health advice 920, since the body temperature of the subject pet sometimes exceeds the normal body temperature range 911 in FIG. 9, the health advice 920 gives an advice concerning the exceedance.

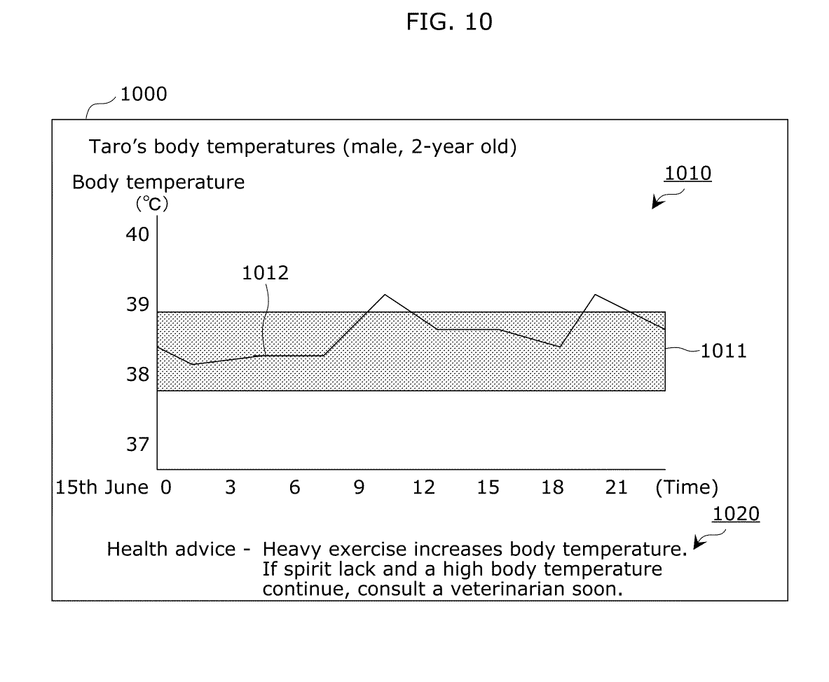

Furthermore, for example, it is also possible that a health information screen 1000 is displayed on the communication terminal 20 as illustrated in FIG. 10, when a bar of 15th June is selected in FIG. 9.

As illustrated in FIG. 10, on the health information screen 1000, there are displayed (a) a graph 1010 showing body temperatures of the pet, Taro, on 15th June and (b) a health advice (message) 1020 related to the body temperatures. In the graph 1010, a vertical axis indicates a body temperature, and a horizontal axis indicates a time on 15th June. The graph 1010 displays a normal body temperature range 1011 and a line graph 1012. The normal body temperature range 1011 is the same as the normal body temperature range 911 in FIG. 9. The line graph 1012 indicates body temperatures of the subject pet at respective times. As illustrated, a body temperature of the subject pet is regularly measured with predetermined time intervals (in this example, every three hours). Like FIG. 9, since the line graph 1012 sometimes exceeds the normal body temperature range 1011 in FIG. 10, the health advice 1020 gives an advice concerning the exceedance.

### Updating of Standard Health Information

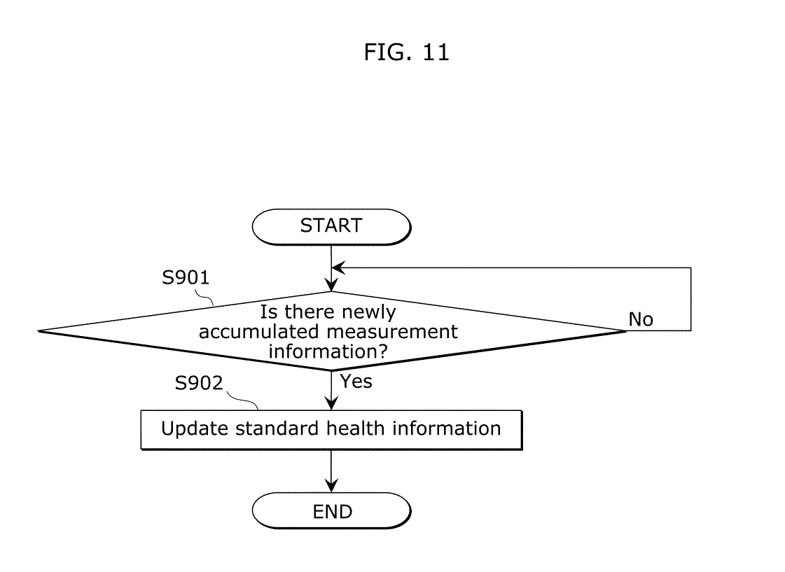

FIG. 11 is a flowchart of updating standard health information in the health management server 10.

First, it is determined whether or not new measurement information is stored into the storage unit 103, and if it is determined that new measurement information is stored, then the processing proceeds to Step S902 (Step S901).

Next, the standard health information updating unit 106 updates standard health information based on the new measurement information, and registers the updated standard health information into the standard health information generation unit 107.

The timing for the standard health information updating is as follows, but not limited to these timings.

The standard health information updating may be performed at timings, for example: every time new measurement information is received; regularly; when a predetermined total amount of pieces of new measurement information is stored; and the like.

If the standard health information is updated in the above-described manner, it is possible not only to always hold the latest standard health information, but also to classify the pieces of information in the standard health information into more detailed items for pets, such as a breed, a pedigree, an age, a weight, a region, position information, a season, weather, a time zone, and the like, as more pieces of measurement information of various pets are gathered. By classifying pieces of information in the standard health information into detailed items, it is possible to enhance an accuracy of generated pet health information.

It should be noted that the order of steps in each of the flowcharts is not limited to the above, but, of course, may be changed as long as the same effects can be produced.

It should be noted that it has been described in the present embodiment that the measurement terminal 30 transmits measurement information to the communication terminal 20, but it is also possible that the measurement terminal 30 transmits measurement information directly to the health management server 10.

### Microchip

In recent years, in order to identify a pet and determine an owner of the pet, a microchip having identification information is embedded in a body of the pet.

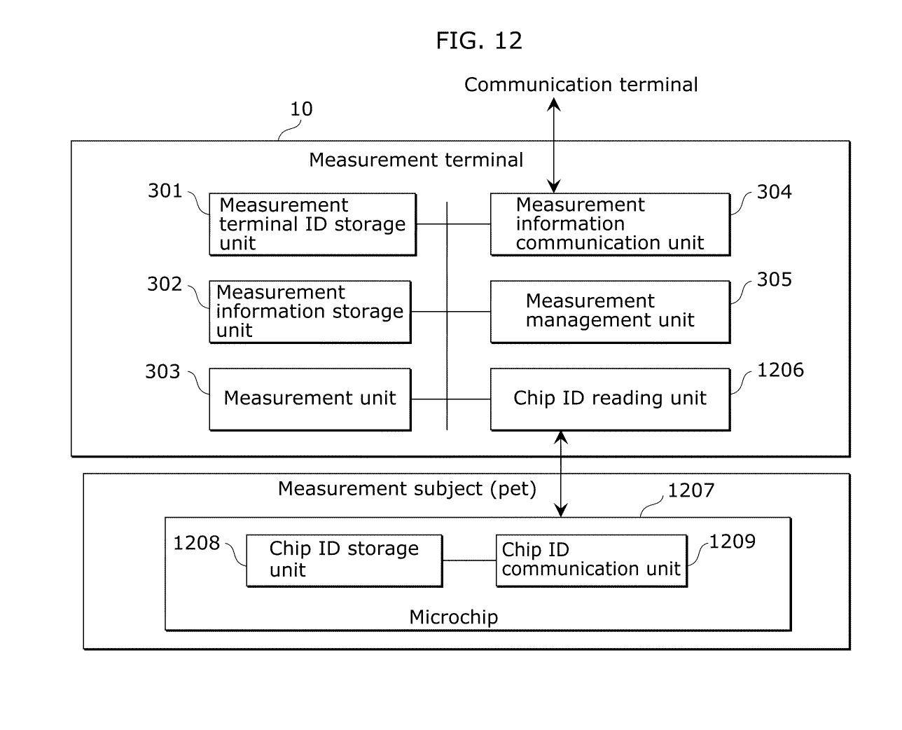

FIG. 12 is a diagram illustrating a configuration of a measurement terminal 1200 and a microchip 1207, assuming that the microchip 1207 is embedded in a pet. In other words, if the microchip 1207 is embedded in the body of the pet, it is possible to adopt the measurement terminal 1200 illustrated in FIG. 10.

The microchip 1207 includes a chip ID storage unit 1208 that stores identification information (hereinafter, referred to as a “chip ID”), and a chip ID communication unit 1209 that transmits the chip ID.

The measurement terminal 1200 includes: the measurement terminal ID storage unit 301, the measurement information storage unit 302, the measurement unit 303, the measurement information communication unit 304, and the measurement management unit 305 which have been described as the structural elements in the measurement terminal 30 according to Embodiment 1. In addition, the measurement terminal ID storage unit 301 includes a chip ID reading unit 1206 that obtains the chip ID from the chip ID communication unit 1209. It should be noted that the measurement terminal ID storage unit 301, the measurement information storage unit 302, the measurement unit 303, the measurement information communication unit 304, and the measurement management unit 305 have the same structure as the corresponding structural elements in the measurement terminal 30, so that they are not explained again below.

When biological information (measurement information) of the subject pet is generated, the measurement terminal 1200 communicates with the chip ID communication unit 1209 in the microchip 1207 and thereby obtains a chip ID of the pet. Then, the measurement terminal 1200 transmits the obtained chip ID, a measurement terminal ID of the measurement terminal 1200, and generated measurement information are transmitted to a corresponding one of the communication terminals 20. Next, the communication terminal 20 transmits the chip ID, the measurement terminal ID, the measurement information, and also a user ID of a user, to the health management server 10.

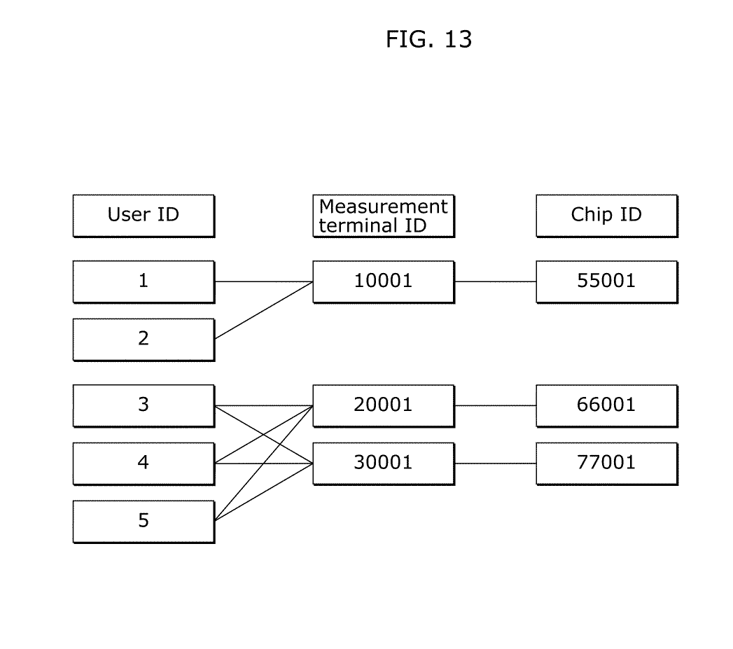

FIG. 13 illustrates a diagram illustrating an ID management method by the ID management unit 101 in the case where microchips are used.

As illustrated in FIG. 13, each of chip IDs is associated with a corresponding one of measurement terminal IDs, and each of the measurement terminal IDs is associated with a plurality of users as N-to-N relationship. Here, as described previously, assuming that the measurement terminal 1200 may be broken or that a user uses a plurality of the measurement terminal 1200 for a single pet, it is possible to associate a single chip ID with a plurality of measurement terminal IDs as 1-to-N relationship.

With the above configuration, it is possible to surely identify individual pets. Even if the measurement terminal 1200 is wrongly attached to a different pet, the chip ID can prevent that wrong measurement information is registered.

It should be noted that the same health management server 10 may manage both pets embedded with microchips and pets without microchips.

### Substitution Registration

A user sometimes leaves his/her pet with a relative, a friend, or a pet hotel as a substitution in a user's long absence.

In this case, if the substitution registers measurement information of the pet (hereinafter, the registration is referred to as “substitution registration”), the user can see health information of the pet on his/her personal computer, mobile phone, or the like even at a distant place.

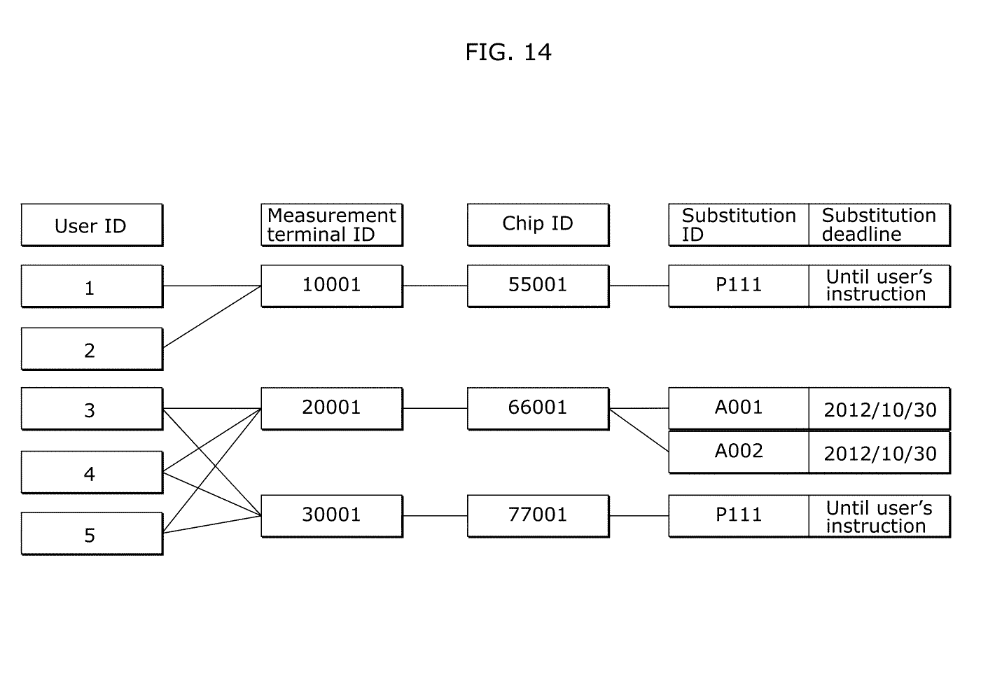

FIG. 14 is a diagram illustrating an ID management method for the substitution registration.

If the substitution is a pet hotel that is previously registered in the health management system 100, a pet hotel ID is issued for the pet hotel.

For example, a substitution ID=“P111” is a pet hotel ID of a registered pet hotel. When the user leaves his/her pet in the pet hotel, a pre-registered pet hotel ID=“P111” as a substitution ID is associated with a chip ID or pet ID of the pet.

When the user asks a substitution, such as a relative or a friend, who has not yet used the health management server 10, to perform substitution registration instead of the user, the ID issuing unit 105 receives a request from the user, then issues a substitution ID for the substitution and notifies the substitution ID to the user. The user notifies the substitution ID, such as a substitution ID=“A001” or a substitution ID=“A002”, to the relative or friend with whom the user leaves the pet. The relative or friend inputs the substitution ID to a Smartphone or mobile phone of the relative or friend, so as to use the Smartphone or mobile phone as a communication terminal.

The substitution ID may have a deadline. In this case, if a date is designated as the deadline, registration using the substitution ID is not allowed after the date. It is also possible that such a deadline is not set, but the user can instruct prohibition of registration using the substitution ID.

If pieces of information such as breeds and ages and care information of pets which have ever stayed in each of pet hotels are accumulated as histories, the user can select a pet hotel suitable for the user's pet. If emotion and biological information of the pet that has stayed in a pet hotel are accumulated, the user can check whether or not the pet has been comfortable in the pet hotel and it is expected that the user uses the pet hotel again.

It is also expected that a provider of the health management system can receive payments, such registration fees or referral fees, from pet hotels.

### Use by Veterinarian

The health management server 10 may be used by veterinarians.

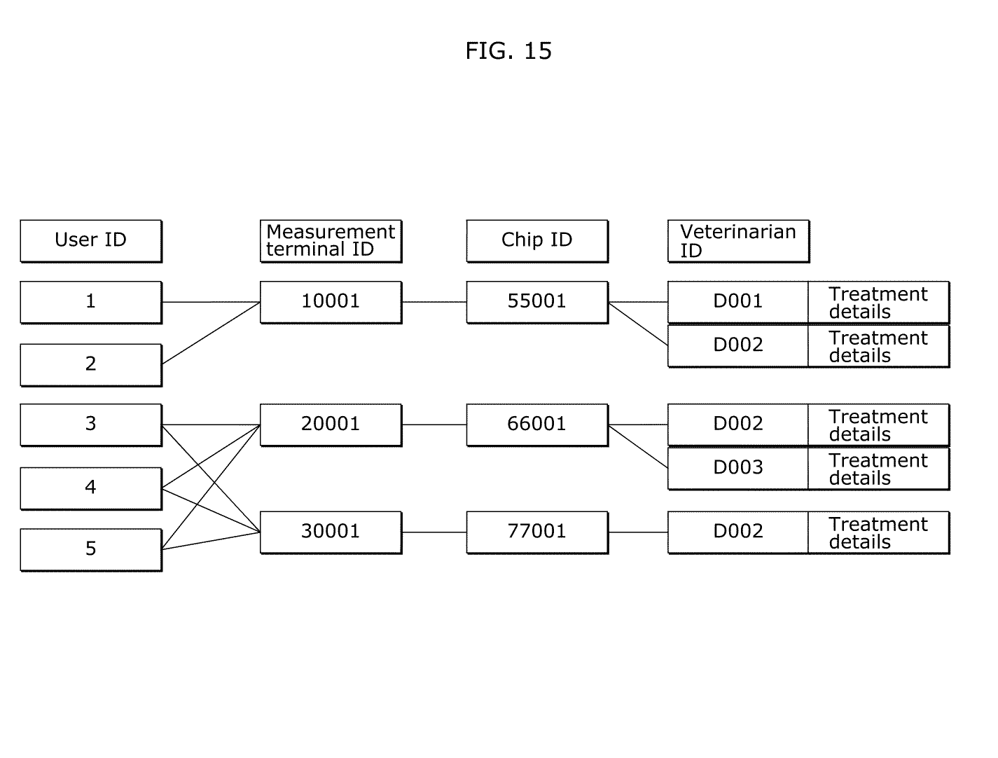

FIG. 15 is a diagram illustrating management of veterinarian IDs for identifying respective veterinarians.

A veterinarian ID is previously issued to a veterinarian who uses the health management server 10. In consulting a veterinarian, a user provide the right to refer to pieces of information regarding a user's pet to a veterinarian ID of the veterinarian. More specifically, the ID management unit 101 manages the veterinarian ID in association with a chip ID or pet ID of the user's pet. Therefore, the veterinarian is able to refer to measurement information, health information, and the like of the pet which are associated with the veterinarian ID of the veterinarian. It is therefore expected that the veterinarian can give the pet appropriate treatment, in addition, it is also possible to register treatment details, such as medical treatment and medicine prescribed by the veterinarian. Furthermore, if other veterinarians are allowed to refer to the treatment details of the pet, it is expected that a plurality of veterinarians can share the treatment details, and appropriate treatment can be received also from a different veterinarian even if the user moves a house. For example, it is possible that information of a pet having a chip ID=“55001” is referred to and registered by a personal computer, tablet, mobile terminal, or the like of each of a veterinarian having a veterinarian ID=“D001” and a veterinarian having a veterinarian ID=“D002”.

If it is prevented that treatment details registered by a veterinarian are modified by even the user and other veterinarians, a reliability of the treatment details is enhanced. For example, a history of vaccination is not falsified.

If a veterinarian is allowed to refer also to the standard health information, the veterinarian can use health information of the pet in research.

If treatment details of a veterinarian are stored as a history and the user can search the treatment details, the user can select a suitable veterinarian according to a breed or a kind of disease of the pet.

A provider of this health management system can receive referral fees or registration fees from veterinarians using this system.

The user can receive health advices for the pet from a registered veterinarian with charge or for free.

It is also possible that the ID management unit manages only association among veterinarian IDs, chip IDs, and pet IDs, and treatment details and the like are registered in a different storage unit or a server different from the health management server. In this case, the treatment details and the like can be searched for or referred to, based on the veterinarian IDs, the chip IDs, and the pet IDs.

### Use by Insurance Providers

In recent years, services such as life insurance for pets have been recommended. It is also possible that insurance providers use the health management system according to the present embodiment.

The health management server 10 issues an insurance provider ID to an insurance provider. The insurance provider allows a user's communication terminal 20 to search for or referred to insurance services provided from the insurance provider.

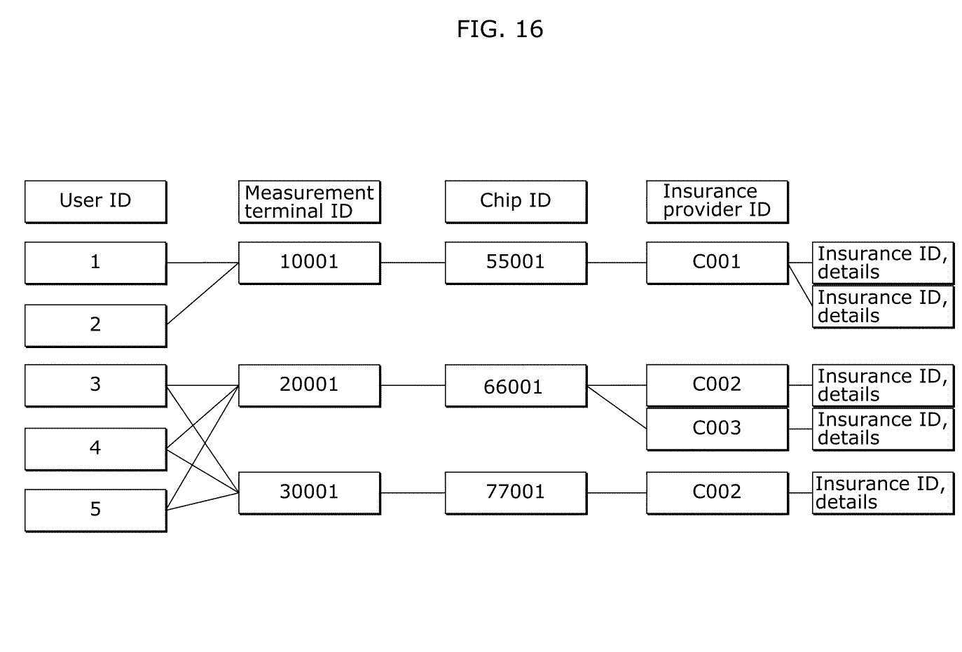

FIG. 16 illustrates that the ID management unit 101 manages insurance providers ID, insurance IDs for identifying respective insurance policies, and insurance details in association with respective chip IDs or pet IDs. For example, a pet having a chip ID=“55001” has two insurance policies of an insurance provider having an insurance provider ID=“C001”, while a pet having a chip ID=“66001” has one insurance policy of an insurance provider having an insurance provider ID=“C002” and one insurance policy of an insurance provider having an insurance provider ID=“C003”.

The health management server 10 can recommend popular insurance providers or insurance services of the insurance providers to a user, based on a breed, an age, and the like of a pet of the user. Therefore, the user can select insurance services suitable for the pet, and it is expected that the insurance provider can increase a close rate. If insurance contract is established through the health management system, a provider of the health management system can receive a payment from the insurance provider. If the health management system recommends insurance services of an insurance provider to users, a provider of the health management system can receive an advertisement fee.

It is also possible that the ID management unit manages only association of insurance provider IDs with chip IDs or pet IDs, and insurance details and the like are registered in a different storage unit or a server different from the health management server. In this case, the insurance details and the like can be searched for or referred to, based on the insurance provider IDs and the chip IDs or pet IDs.

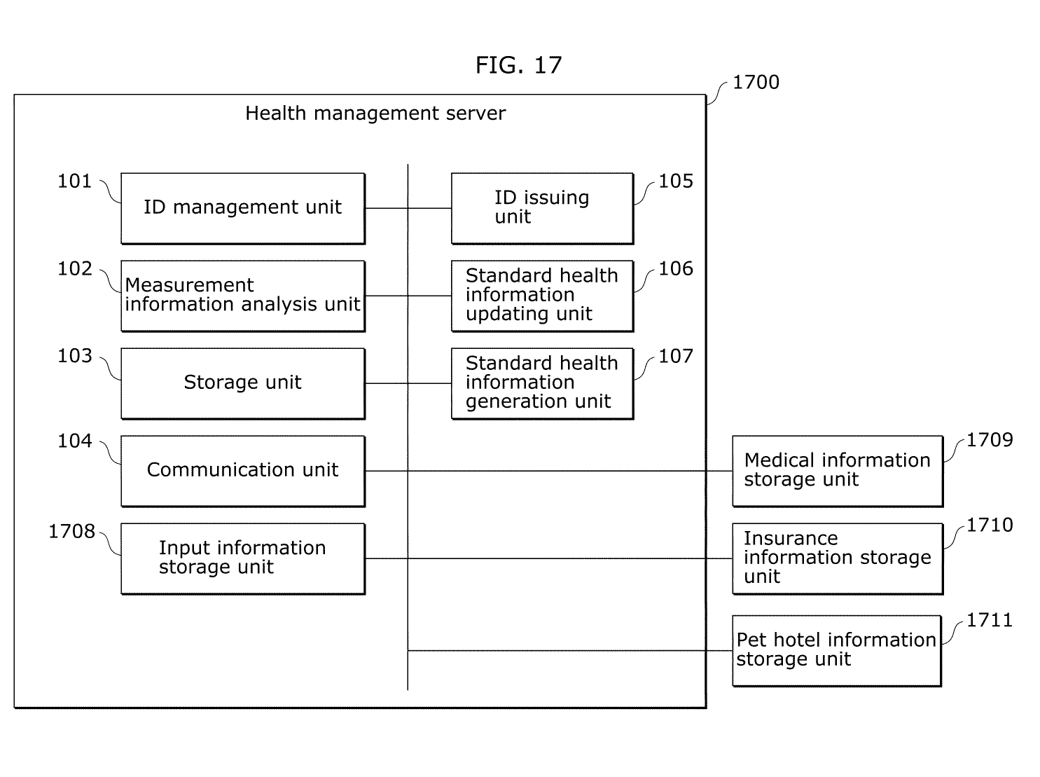

FIG. 17 is a diagram illustrating a structure of a health management server 1700 that is a variation of the health management server 10. As illustrated in FIG. 17, the health management server 1700 includes not only the ID management unit 101, the measurement information analysis unit 102, the storage unit 103, the communication unit 104, the ID issuing unit 105, the standard health information updating unit 106, and the standard health information generation unit 107 which are the same as the structural elements in the health management server 10 according to Embodiment 1, and also an input information storage unit 1708. Furthermore, the health management server 1700 is connected to a medical information storage unit 1709, an insurance information storage unit 1710, and a pet hotel information storage unit 1711. The medical information storage unit 1709 stores the above-described information of veterinarians. The insurance information storage unit 1710 stores the above-described information of insurance providers. The insurance information storage unit 1711 stores the above-described information of pet hotels. These storage units 1709 to 1711 may be different independent servers. With the above structure, it is possible to refer to associated information searched out based on at least one of a chip ID, a pet ID, a pet hotel ID, a veterinarian ID, and an insurance provider ID.

As described above, the health management server 10 is capable of providing services in cooperation with various businesses. Pet hotels, veterinarians, and insurance providers are merely examples of the businesses. The businesses are not limited to the above. The health management server 10 can cooperate with pet supply manufacturers manufacturing toys, fashion, and the like, pet food manufacturers, and the like.

Regarding pet supplies, it is possible that correlations among a breed, an age, and measurement information of a pet using the pet supply are accumulated, and provided to a user of the pet.

Regarding pet foods, a user registers information of pet food by using a barcode or the like before giving the pet food to a user's pet, and the pet food information is accumulated with measurement information such as information indicating emotion or biological information when or after the pet eats the pet food If the information is prevented to the user, the user can select pet food which the pet likes or pet food which is good for health.

It is expected that a provider of the health management system can receive an advertisement fee or a payment from each of such businesses.

Furthermore, using the communication terminal 20, the user can register, in the health management server 10, captured photographs, comments, diaries, blogs, and the like. As the user likes, the registered information may be published to other users. Moreover, these pieces of information may be registered in collaboration with other services such as Twitter® or Facebook®.

It should be noted that it has been described that a chip ID of the microchip 1207 is obtained by the chip ID reading unit 1206 in the measurement terminal 1200, but it is also possible that the communication terminal 20 is provided with a chip ID reading unit so that the communication terminal 20 obtains the chip ID from the microchip 1207.

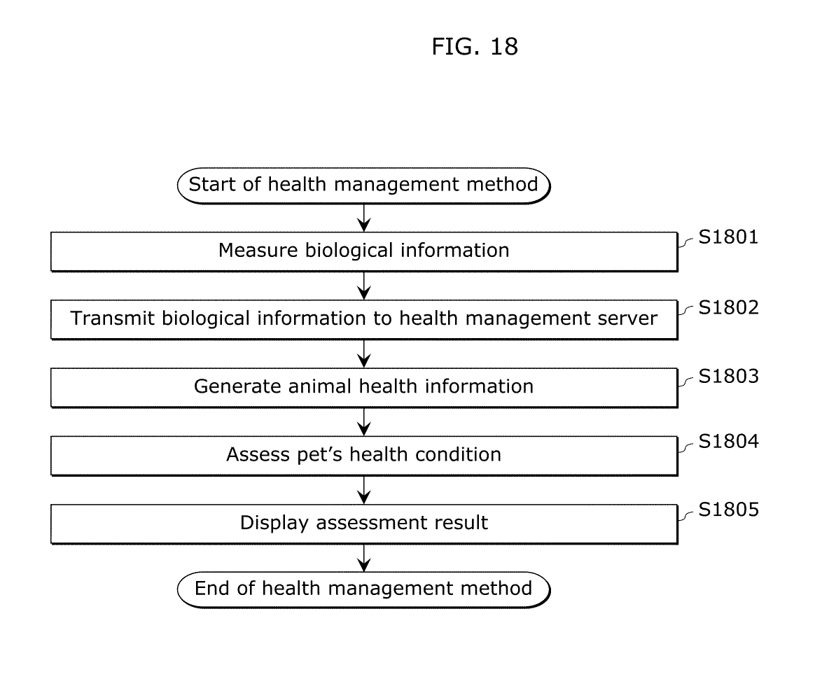

It should be noted that, in Embodiment 1, the health management method includes various processing steps, but any steps may be possible for the present invention as long as at least the flowchart of FIG. 18 is included.

More specifically, the health management method may include at least the following four steps.

First, for each of pets, an animal measurement terminal (measurement terminal) corresponding to the pet among the plurality of measurement terminals 30 generates biological information of the animal (pet) (S1801: measurement step).

Next, for each of the pets, biological information of the pet which is generated at Step S1801 is obtained (S1802: obtainment step).

Next, for each of the pets, the health management server 10 generates animal health information indicating standard health condition of the pets, based on the pieces of biological information of the pets which are obtained at Step S1802 (S1803: generation step).

Next, for each of the pets, the animal health information generated at Step S1803 is compared to the biological information of the corresponding pet which is generated at Step S1801, thereby assessing health conditions of the pet (S1804: assessment step).

Next, the assessment result of the health conditions of the pet which is assessed at Step S1804 is displayed on the display unit 201 (S1805: display step).

### Embodiment 2

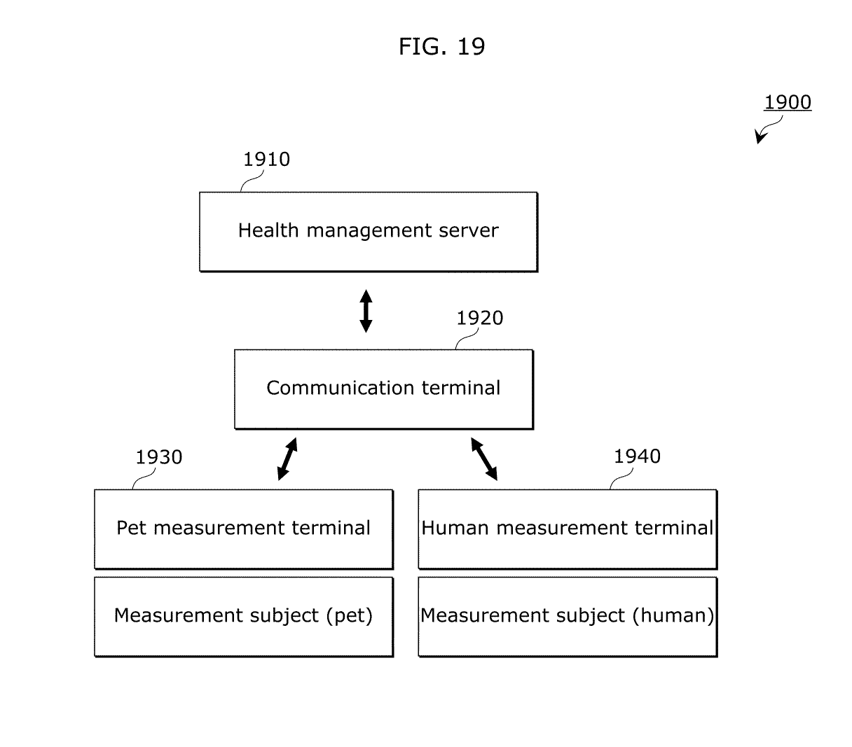

FIG. 19 is a block diagram illustrating a main part of a health management system according to Embodiment 2 of the present invention.

As illustrated in FIG. 19, the health management system 1900 according to Embodiment 2 includes pet (animal) measurement terminals 1930, human measurement terminals 1940, communication terminals 1920, and a health management server 1910. Each of the pet measurement terminals 1930 generates, as measurement information, biological information or a behavior history of the subject pet, and transmits the generated measurement information to the corresponding communication terminals 1920. Each of the human measurement terminals 1940 generates, as measurement information, biological information or a behavior history of an owner of the subject pet, and transmits the generated measurement information to a corresponding one of the communication terminals 1920. The communication terminal 1920 transmits the pieces of measurement information received from the pet measurement terminal 1930 and the human measurement terminal 1940, to the health management server 1910. The health management server 1910 determines health conditions based on the received pieces of measurement data, and notify each of the communication terminals 1920 of health information indicating the determined health conditions of the corresponding pet.

The respective structural elements are described in more detail.

### Measurement Terminal

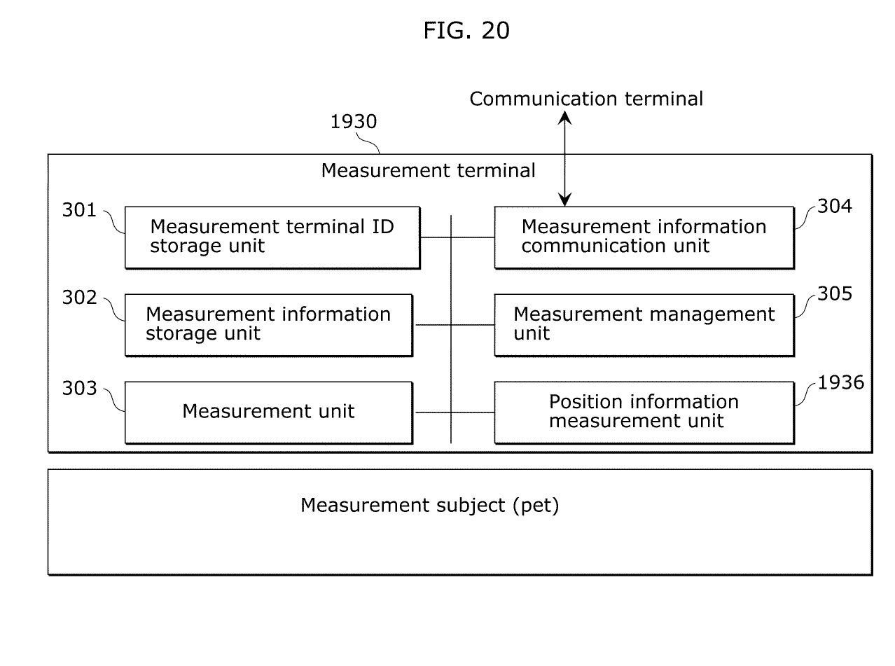

FIG. 20 is a block diagram illustrating a main structure of the pet measurement terminal 1930.

The pet measurement terminal 1930 includes not only the measurement terminal ID storage unit 301, the measurement information storage unit 302, the measurement unit 303, the measurement information communication unit 304, and the measurement management unit 305, but also a position information measurement unit 1936 that determines a present position. The structure except the measurement terminal ID storage unit 301, the measurement information storage unit 302, the measurement unit 303, the measurement information communication unit 304, and the measurement management unit 305 is the same as the structure of the measurement terminal 30, so that it is not explained again. The position information measurement unit 1936 is capable of determining a position of the pet measurement terminal 1930. The position information measurement unit 1936 generates position information in which a position arrived by the pet measurement terminal 1930 and a time of determining the position are associated with each other. The generated position information is stored in the measurement information storage unit 302.

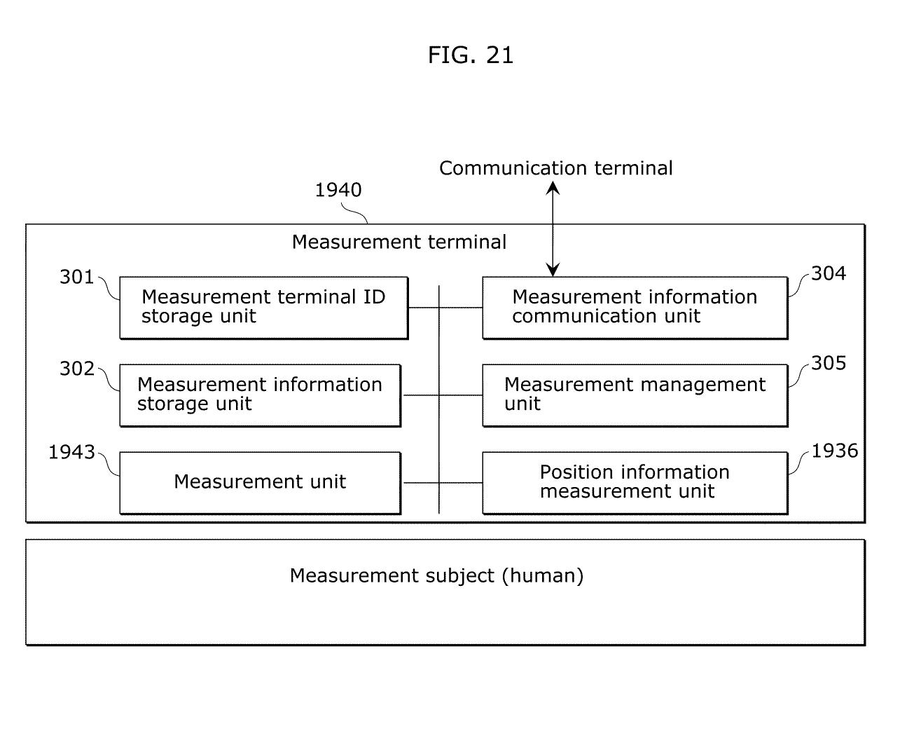

FIG. 21 is a block diagram illustrating a main structure of the human measurement terminal 1940.

The human measurement terminal 1940 includes not only the measurement terminal ID storage unit 301, the measurement information storage unit 302, the measurement information communication unit 304, the measurement management unit 305, and the position information measurement unit 1936, but also a measurement unit 1943 that generates biological information or a behavior history which includes at least an activity amount of a subject person. The structure except the measurement terminal ID storage unit 301, the measurement information storage unit 302, the measurement information communication unit 304, the measurement management unit 305, and the position information measurement unit 1936 is the same as the structure of the pet measurement terminal 1930, so that it is not explained again.

More specifically, for each of peoples (users), the human measurement terminal 1940 corresponding to a subject person among the plurality of human measurement terminals 1940 generates biological information of the subject person.

### Communication Terminal

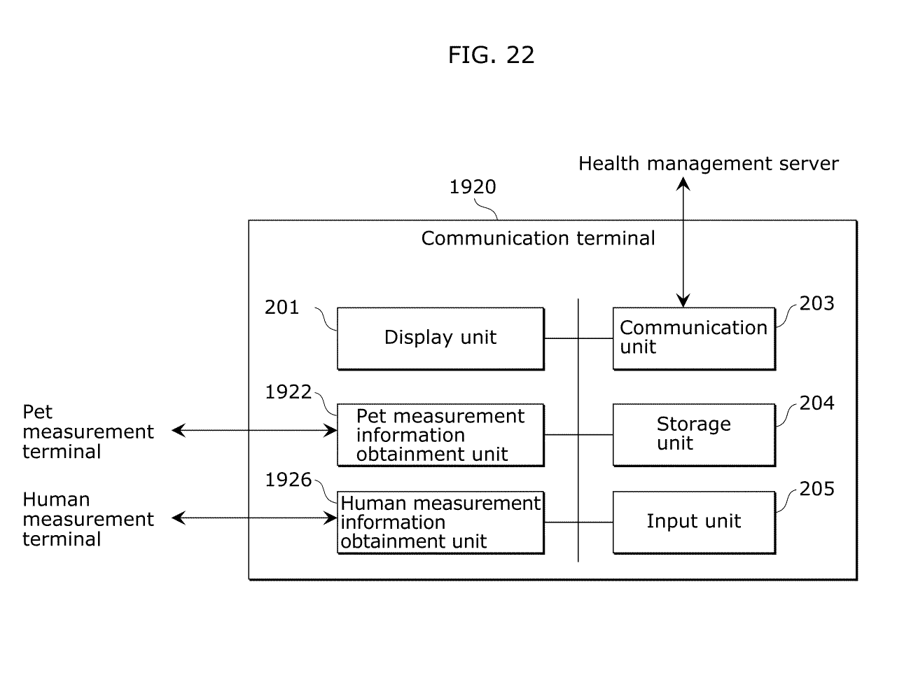

FIG. 22 is a block diagram illustrating a main structure of the communication terminal 1920.

The communication terminal 1920 includes not only the display unit 201, the communication unit 203, the storage unit 204, and the input unit 205, but also a pet measurement information obtainment unit 1922 and a human measurement information obtainment unit 1926. The pet measurement information obtainment unit 1922 communicates with the pet measurement terminal 1930, and therefore obtains at least measurement information and a pet measurement terminal ID of a subject pet. The human measurement information obtainment unit 1926 communicates the human measurement terminal 1940 and therefore obtains at least measurement information and a human measurement terminal ID of a subject person. The storage unit 204 stores a user ID, measurement terminal IDs, pieces of measurement information, and health information. The communication unit 203 transmits the user ID, the measurement terminal IDs, and the pieces of measurement information, to the health management server 1910, and receives the health information from the health management server 1910. The display unit 201 and the input unit 205 have the same structures as the corresponding elements in the communication terminal 20, so that they are not explained again.

More specifically, biological information is obtained for each of measured pets. Here, the biological information of the pet may be obtained by a communication terminal corresponding to the animal measurement terminal among a plurality of the communication terminals 1920. Then, the corresponding communication may terminal transmit the obtained biological information of the pet to the health management server 10. Likewise, more specifically, biological information is obtained for each of measured pets (users). Here, it is also possible that the human biological information is obtained by a communication terminal corresponding to the human measurement terminal 1940 and a communication terminal corresponding to the pet measurement terminal 1930 among a plurality of the communication terminals 1920. Then, the corresponding communication terminal may transmit the obtained biological information of the person to the health management server 10.

### Health Management Server

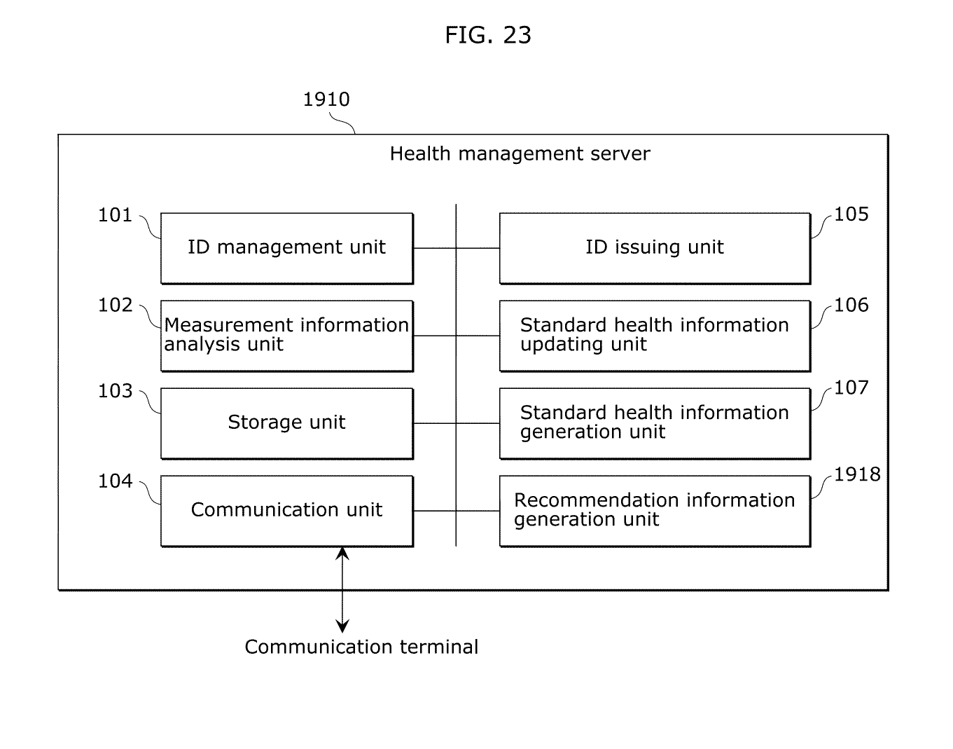

FIG. 23 is a block diagram illustrating a main structure of the health management server 1910.

The health management server 1910 includes the ID management unit 101, the measurement information analysis unit 102, the storage unit 103, the communication unit 104, the ID issuing unit 105, the standard health information updating unit 106, and the standard health information generation unit 107, but also a recommendation information generation unit 1918. The storage unit 103 stores pet IDs and pieces of pet measurement information (pieces of measurement information of pets), and user IDs and pieces of human measurement information (pieces of measurement information of people) The ID management unit 101 manages a link relationship among user IDs, human measurement terminal IDs, pet measurement terminal IDs, and pet IDs.

The standard health information generation unit 107 stores standard health information for pets and standard health information for people. In other words, the standard health information generation unit 107 may obtain, for each of pets, the measurement information indicating biological information of the pet from a corresponding communication terminal. Then, based on the obtained pieces of measurement information regarding the pets, the standard health information generation unit 107 generates animal health information (standard health information of pets) indicating standard health information that is standard for the plurality of animals (pets). Furthermore, the standard health information generation unit 107 obtains, for each of people, biological information from a corresponding communication terminal. Then, based on the obtained pieces of measurement information regarding the people, the standard health information generation unit 107 generates human health information (standard health information of people) indicating standard health information that is standard for people.

The measurement information analysis unit 102 compares a target pet measurement information to the pet standard health information to analyze the target pet measurement information, thereby generating pet health information, and compares target human measurement information to the human standard health information to analyze the target human measurement information, thereby generating human health information. More specifically, the measurement information analysis unit 102 compares, for each of pets, the pet standard health information generated by the standard health information generation unit 107 to the measurement information stored in the storage unit 103, thereby assessing health conditions of the pet. Furthermore, for each of people, the measurement information analysis unit 102 compares the human standard health information generated by the standard health information generation unit 107 to the human measurement information stored in the storage unit 103, thereby assessing health conditions of the person.

The recommendation information generation unit 1918 generates, for a user, recommendation information regarding health of the user and health of a pet of the user from the pet health information and the human health information. The standard health information updating unit 106 updates the pet standard health information and human standard health information based on newly measured pet measurement information and human measurement information. In other words, based on the pet measurement information measured by the pet measurement terminal 1930 and the human measurement information measured by the human measurement terminal 1940, recommendation information for improving pet health conditions is generated and presented to the user who is the subject person.

The pet standard health information is the same as the standard health information as described in Embodiment 1. Furthermore, according to Embodiment 2, changes of position information and an activity amount are accumulated as biological information and a behavior history.

The human standard health information is information regarding standard health of people. The human standard health information is generated based on pieces of biological information to be used as health indicators. For example, the biological information may indicate a body temperature in a normal state, a pulse rate, a respiration rate, a calorie needed daily, an activity amount needed daily. Furthermore, changes of position information and an activity amount are accumulated as biological information and a behavior history. In addition, information indicating diseases and signs of the diseases are also managed. Furthermore, it is also possible to manage standard health information based on a sex, an age, a weight, a region, position information, a season, a weather, and a time zone.

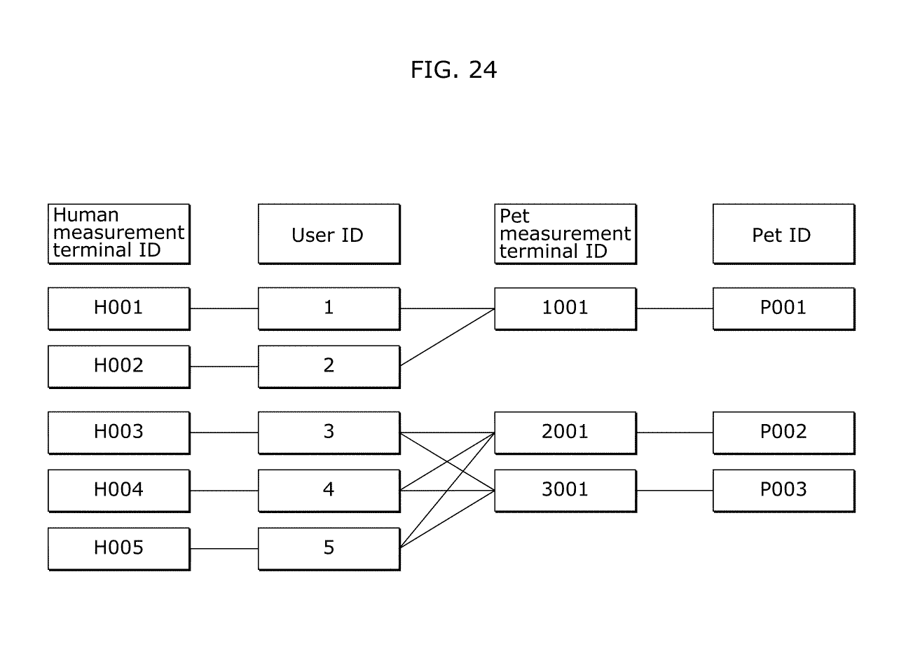

FIG. 24 illustrates a method of managing each of IDs by the ID management unit 101 in the health management server 1910. As illustrated in FIG. 24, a link relationship among user IDs, human measurement terminal IDs, pet measurement terminal IDs, and pet IDs is managed. In this case, in order to use a plurality of the human measurement terminals, it is possible to associate a single user ID with a plurality of human measurement terminal IDs to be registered with a 1-to-N relationship. Likewise, it is possible to associate a single pet ID with a plurality of the pet measurement terminal IDs to be registered with a 1-to-N relationship. Furthermore, it is possible to associate pet measurement terminal IDs with user IDs to be registered with an N-to-N relationship.

As described above, in the health management system with the above configuration, a method for generating recommendation information regarding health based on pieces of measurement information and pieces of standard health information of a person and a pet is described.

### Recommendation

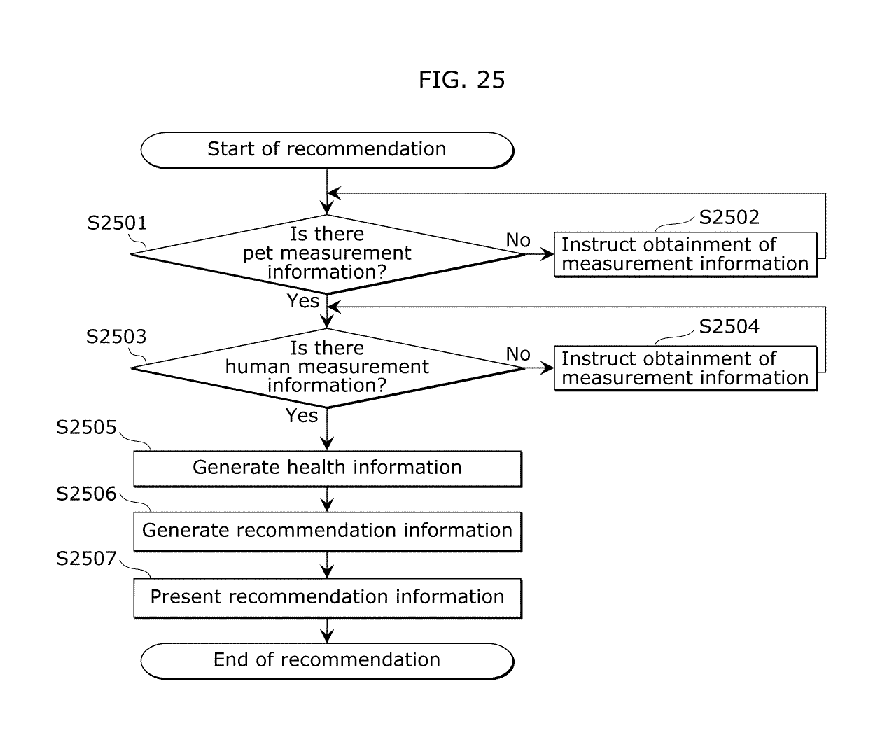

FIG. 25 is a flowchart of generating recommendation information.

First, the health management server 1910 determines whether or not the measurement information storage unit 302 includes pet measurement information which is obtained within a predetermined time period counted back from the present time. If there is pet measurement information which has been obtained within the predetermine time period (Yes at S2501), then the processing proceeds to Step S2503. Otherwise (No at S2501), then the processing proceeds to Step S2502 (Step S2101).

If it is determined at S2501 that there is not pet measurement information (No at S2501), then the communication terminal 1920 is instructed to obtain the pet measurement information (Step S2502).

If it is determined at Step S2501 that there is the pet measurement information (Yes at S2501), then it is determined whether or not the measurement information storage unit 302 includes human measurement information that is obtained in a time period calculated from the present time. If there is a pet measurement information which is obtained within the predetermine time period counted back from the present time (Yes at S2503), then the processing proceeds to Step S2504. Otherwise (No at S2503), then the processing proceeds to Step S2505 (Step S2503).

If it is determined at Step S2503 that there is not human measurement information (No at S2503), the communication terminal 1920 is instructed to obtain the human measurement information (Step S2504).

If it is determined at S2503 that there is human measurement information (Yes at S2503), then the measurement information analysis unit 102 generates health information for a pet and a person based on pet measurement information, pet standard health information, human measurement information, and human standard health information.

Next, the recommendation information generation unit 1918 generates recommendation information from the pieces of health information (Step S2506).

Next, the recommendation information is transmitted to the communication terminal 1920, the communication terminal 1920 presents the recommendation information, and the processing completes (Step S2507).

Examples of the recommendation information as follows.

Now much activity amount does a pet need to be healthy is calculated from an activity amount of the pet in a current day. In the same manner, how much activity does a user need to be healthy is calculated from an activity amount of the user in the current day. Furthermore, as pet standard health information and human standard health information, how much activity amount is produced by walking in each of areas is managed. Therefore, it is possible to derive an appropriate walking route from a necessary activity amount of the pet and a necessary activity amount of the user, and preset the route to the user as recommendation information.

More specifically, the health management server 1910 may calculate an activity amount of the pet from biological information or a behavior history which have been measured by the pet measurement terminal 1930 from the pet, and also calculate an activity amount of the person from biological information or a behavior history which have been measured by the human measurement terminal 1940 from the person. It should be noted that the calculation of the activity amounts may be performed by the communication terminal 1920. The activity amount of a pet or person may be calculated based a distance which the pet or person moves. Then, the recommendation information generation unit 1918 generates, as recommendation information, a walking route having a distance corresponding to the pet's activity amount and the person's activity amount, thereby presenting the recommendation information to the user as the person.

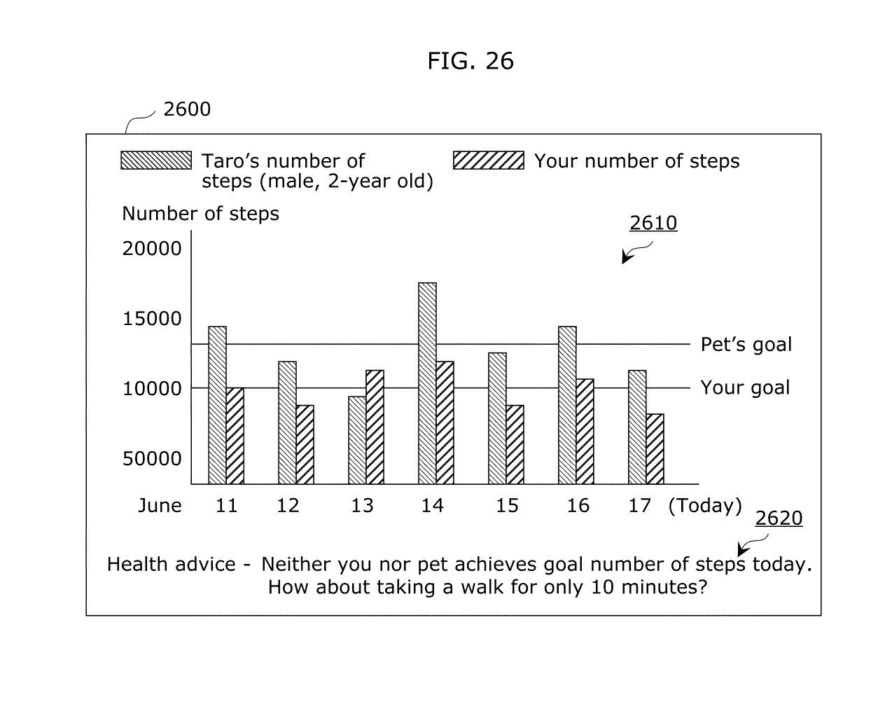

Examples of the presented recommendation information are described with reference to FIGS. 26 to 28.

FIG. 26 is an example of a recommendation information screen 2600 displayed on the communication terminal 1920.

As illustrated in FIG. 26, on the recommendation information screen 2600, there are displayed: a graph 2610 showing, for a pet, Taro, and a Taro's owner, the number of steps in the last seven days; and a health advice (massage) 2620 related to the numbers of steps. In the graph 2610, a vertical axis indicates the number of steps, and a horizontal axis indicates a date. The graph 2610 shows Taro's goal number of steps, owner's goal number of steps, Taro's number of steps in a day, and the owner's number of steps in a day. The Taro's goal number of steps is retrieved from classification corresponding to Taro (namely, subject pet) among the standard health information. The owner's goal number of steps is retrieved from classification corresponding to the owner (namely, subject person) among the standard health information. Thereby, it is possible to determine, for each of Taro and the owner, whether or not the number of steps which indicates an activity amount in a day reaches the goal the number of steps. The health advice 2620 recommends walking with the pet, because neither the pet nor the owner has not reached the goal number of steps on the current day (17th June) in FIG. 26.

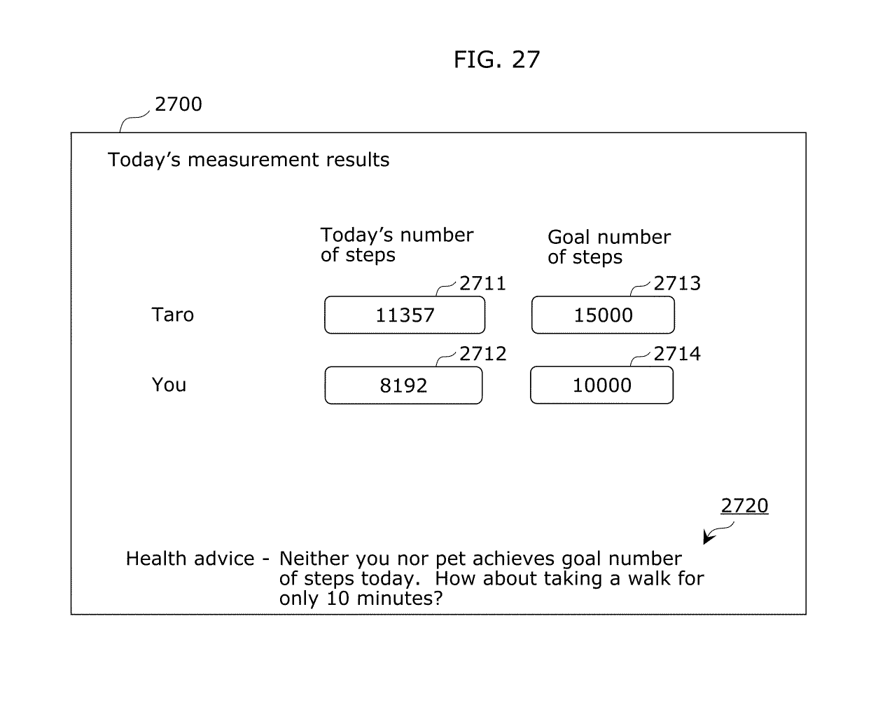

Furthermore, for example, it is also possible that a recommendation information screen 2700 is displayed on the communication terminal 1920 as illustrated in FIG. 27, when a bar of 17th June is selected in FIG. 26.

As illustrated in FIG. 27, on the recommendation information screen 2700, there are displayed the number of steps 2711 of a pet, Taro, on a current day (17th June), the number of steps 2712 of an owner of Taro on the current day, a goal number of steps of Taro 2713, a goal number of steps of the owner 2714, and a health advice (message) 2720 related to the number of steps. Like FIG. 26, the health advice 2720 in FIG. 27 recommends walking with the pet, because neither the pet nor the owner has not reached the goal number of steps on the current day (17th June).

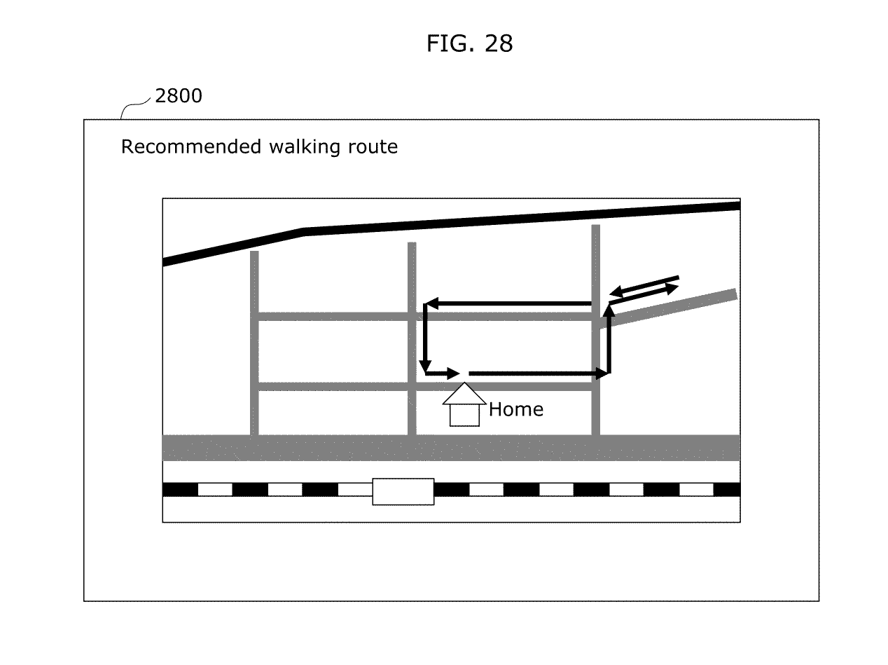

Furthermore, as illustrated in FIG. 28, a walking route may be added in the recommendation information.

FIG. 28 is an example of a recommendation information screen 2800 displayed on the communication terminal 1920.

It is also possible to recommend, as the health advice, not only a ten-minute walk in FIGS. 26 and 27 but also a walking route as ten-minute exercise.

It is further possible to determine, from measurement information of a pet which is stored in the measurement information storage unit 302, which area the pet is happy to walk around, and set the route as recommendation information.

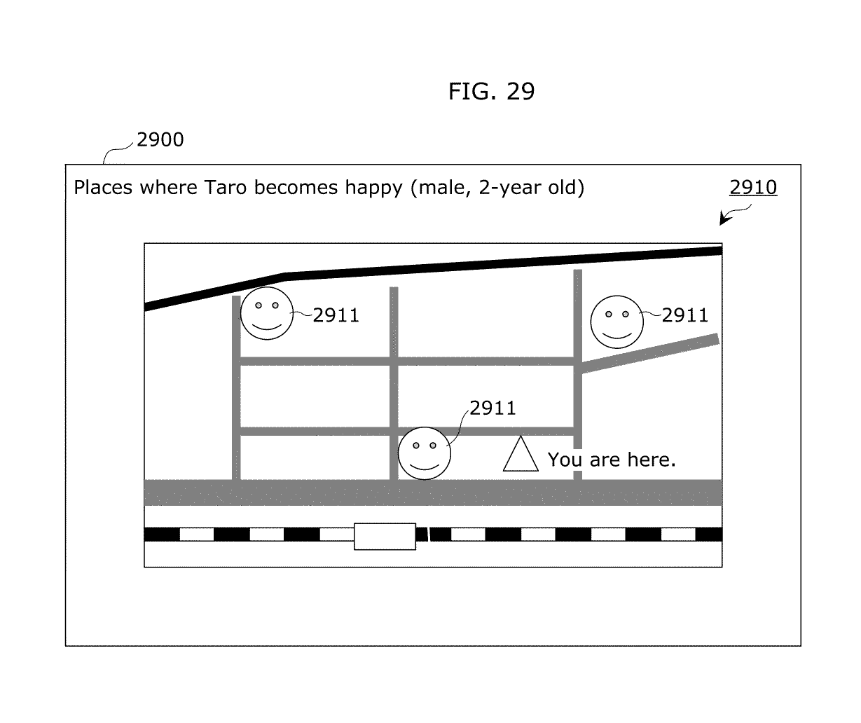

For example, as illustrated in FIG. 29, along routes where the pet has ever walked, it is possible to specify positions determined as positions where the pet have been happy, and therefore recommend a walking rout including the specified positions. FIG. 29 shows a map 2910 near home and positions 2911 where the pet likes. In generating the walking route as recommendation information, it is possible to recommend, as illustrated in FIG. 28, a ten-minute walking route including positions determined as positions where the pet has been happy.

More specifically, the above-described recommendation information is presented to the user in the following processing. For each of pets, the pet measurement terminal 1930 determines a position of the pet at a time of measuring biological information of the pet. Then, for each of the pets, a corresponding communication terminal obtains position information indicating the determined position of the pet, and transmits the obtained position information to the health management server 1910. Next, based on the biological information of the measured pet, it is determined whether or not the pet is happy. Then, based on the position information at the time of measuring the biological information of the pet when it is determined that the pet is happy, a walking route including the position indicated by the position information is generated and recommended to a human user.

It is also possible to determine a walking route based on a lower activity amount among a necessary activity amount of a pet and a necessary activity amount of an owner, thereby recommending the determined walking route as recommendation information.

It is further possible, for example, to change a walking route to a different walking route that requires a more activity amount in walking, and notify the resulting walking route as recommendation information. Therefore, it is possible to first recommend a simple and short-time walking route to persuade a user to walk, and then, at a time when the user is expected to be excited in the walk, change the first walking route to a longer walking route. As a result, user's health is improved.

Furthermore, if it is determined that one of a person and pet is unwell, recommendation information is generated to recommend not walking but exercise for the other one of the person and the pet who is not unwell. For example, if the pet is not unwell, playing with a certain toy is recommended. On the other hand, if the person is not unwell, an indoor training menu is generated as recommendation information. Thereby, it is possible that one of the pet and the person who is unwell is not recommended to do hard exercise and the other one of the pet and the person who is healthy is recommended to do necessary exercise. As a result, both of the pet and the person improve their health.

Furthermore, by obtaining chronic disease information indicating chronic disease, allergy, and the like of a person or a pet, it is possible to recommend, as recommendation information, restriction on activities not to be affected by the disease, allergy, or the like indicated by the chronic disease information of the person or pet.

Furthermore, it is possible that weather forecast is obtained and if it is rainy on a next day, a walking route having a more activity amount is selected as recommendation information.

Furthermore, it is possible to specify breeds which a subject pet does not like, based on past measurement information of the subject pet, pieces of measurement information of other pets, and thereby recommend, as recommendation information, a route avoiding a time zone or routes in which pets of the breeds that the subject pet does not like walk. It is also possible that, if pieces of current position information of the pets of the breeds that the subject pet does not like can be obtained, positions indicated in the current position information are not included in the walking route.

Furthermore, it is possible to set, as recommendation information, a walking route for avoiding or guiding to a place or time where a large number of pets are gathered.

Furthermore, a walking route as recommendation information may be determined according to a breed, health conditions, and an age of a subject pet. For example, for old dogs, small dogs which do not like high steps, and the like, a walking route having more flat areas may be recommended as recommendation information. Moreover, it is possible to generate recommendation information suitable for a pet or user, for example, by recommending, as the recommendation information, a walking route having more flat areas to a user who is old or has a walking difficulty.

Furthermore, when a plurality of users, such as family, take care of the same pet, it is possible to recommend walking with the pet to a user who needs the largest activity amount among them, thereby improving family health.

It is also possible to recommend walking with the pet to a user who is the healthiest.

As described above, according to the present embodiment, by using pet measurement information, human measurement information, pet standard health information, and human standard health information, it is possible to generate recommendation information suitable for a pet and a user.

Furthermore, using the communication terminal 20, the user can register, in the health management server 10, captured photographs, comments, diaries, blogs, and the like. As the user likes, the registered information may be published to other users. Moreover, these pieces of information including recommendation information may be registered in collaboration with other services such as Twitter® or Facebook®.

Although the present invention has been described using the above embodiments, the present invention is, of course, not limited to them. The present invention may also be implemented as the followings.

(1) Each of the above-described devices is a computer system including a microprocessor, a Read Only Memory (ROM), a Random Access Memory (RAM), a hard disk unit, a display unit, a keyboard, a mouse, and the like. The RAM or the hard disk unit holds a computer program. The microprocessor operates according to the computer program, thereby causing each of the above-described devices to perform its functions. Here, the computer program consists of combinations of instruction codes for issuing instructions to the computer to execute predetermined functions. Each of the above-described devices is not limited to a computer system including all of a microprocessor, a ROM, a RAM, a hard disk unit, a display unit, a keyboard, a mouse, and the like, but may be a computer system including a part of them.

(2) It should be noted that a part or all of the structural elements included in each of the above-described devices may be implemented into a single Large Scale Integration (LSI). The system LSI is a super multi-function LSI that is a single chip into which a plurality of structural elements are integrated. More specifically, the system LSI is a computer system including a microprocessor, a ROM, a RAM, and the like. The RAM holds a computer program. The microprocessor operates according to the computer program to cause the system LSI to perform its functions.

It should also be noted that each of the structural elements included in each of the above-described devices may be implemented to a single chip, or a part or all of them may be integrated into a single chip.

Here, the integrated circuit is referred to as a LSI, but the integrated circuit can be called an IC, a system LSI, a super LSI or an ultra LSI depending on their degrees of integration. The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

(3) It should also be noted that a part or all of the structural elements included in each of the above-described devices may be implemented into an Integrated Circuit (IC) card or a single module which is attachable to and removable from each of the above-described devices. The IC card or the module is a computer system including a microprocessor, a ROM, a RAM, and the like. The IC card or the module may include the above-described super multi-function LSI. The microprocessor operates according to the computer program to cause the IC card or the module to perform its functions. The IC card or the module may have tamper resistance.

(4) It should also be noted that the present invention may be the above-described method. The present invention may be a computer program causing a computer to execute the method, or digital signals indicating the computer program.

It should also be noted that the present invention may be a computer-readable recording medium on which the computer program or the digital signals are recorded. Examples of the computer-readable recording medium are a flexible disk, a hard disk, a Compact Disc (CD)-ROM, a magnetooptic disk (MO), a Digital Versatile Disc (DVD), a DVD-ROM, a DVD-RAM, a BD (Blue-ray® Disc), and a semiconductor memory. The present invention may be digital signals recorded on the recording medium.

It should also be noted in the present invention that the computer program or the digital signals may be transmitted via an electric communication line, a wired or wireless communication line, a network represented by the Internet, data broadcasting, and the like.

It should also be noted that the present invention may be a computer system including a microprocessor operating according to the computer program and a memory storing the computer program.

It should also be noted that the program or the digital signals may be recorded onto the recording medium to be transferred, or may be transmitted via a network or the like, so that the program or the digital signals can be executed by a different independent computer system.

(5) It should be noted that a part or all of the structural elements included in each of the above-described devices may be implemented according to virtual technology.

(6) It should be noted that the above-described embodiments and variations may be combined.

### INDUSTRIAL APPLICABILITY

The health management system according to the present invention is suitable for health management on pets and people, and suitable for information provision systems that provide information to the third party, such as veterinarians, insurance providers, and pet hotels, based on the health information.

### REFERENCE SIGNS LIST

10, 1910, 1700 health management server
20, 1920 communication terminal
30, 1200 measurement terminal
100, 1900 health management system
101 ID management unit
102, 1612 measurement information analysis unit
103, 1613 storage unit
104 communication unit
105 ID issuing unit
106, 1616 standard health information updating unit
107, 1617 standard health information generation unit
201 display unit
202 measurement information obtainment unit
203 communication unit
204 storage unit
205 input unit
301 measurement terminal ID storage unit
302 measurement information storage unit
303 measurement unit
304 measurement information communication unit
305 measurement management unit
1206 chip ID reading unit
1207 microchip
1208 storage unit
1209 communication unit
1708 input information storage unit
1709 medical information storage unit
1710 insurance information storage unit
1711 pet hotel information storage unit
1918 recommendation information generation unit
1922 pet measurement information obtainment unit
1926 human measurement information obtainment unit
1930 pet measurement terminal
1936 position information measurement unit
1940 human measurement terminal
1943 measurement unit

1. A health management method used in a health management system that manages health of a plurality of animals, the health management method comprising:
measuring biological information of each of the animals by a corresponding animal measurement terminal among a plurality of measurement terminals to generate pieces of biological information of the animals;
obtaining the pieces of the biological information of the animals which are generated in the measuring;
generating animal health information indicating a standard health condition of the animals, based on the pieces of the biological information of the animals which are obtained in the obtaining;
comparing, for each of the animals, the animal health information generated in the generating of the animal health information to the biological information measured in the measuring, thereby assessing a health condition of the each of the animals; and
displaying, on a display unit, a result of the assessing of the health condition of the each of the animals.

2. The health management method according to claim 1,
wherein, in the measuring, the corresponding animal measurement terminal measures the biological information of the each of the animals at predetermined timing, and
the health management method further comprises
updating the animal health information generated in the generating of the animal health information, based on a latest piece of biological information among the pieces of the biological information of the animals which are generated in the measuring.

3. The health management method according to claim 1,
wherein the measuring further includes measuring human biological information of each of people by a corresponding human measurement terminal among the plurality of the measurement terminals to generate pieces of human biological information of the people,
the obtaining further includes obtaining the pieces of the human biological information of the people which are generated in the measuring,
the generating of the animal health information further includes generating human health information indicating a standard health condition of the people based on the pieces of the human biological information of the people which are generated in the measuring of the human biological information,
the comparing further includes comparing, for each of the people, the human health information generated in the generating of the human health information to the human biological information measured in the measuring of the human biological information, thereby assessing a health condition of the each of the people, and
the displaying further includes displaying, on the display unit, a result of the assessing of the health condition of the each of the people.

4. The health management method according to claim 3, further comprising
generating recommendation information based on the biological information of the each of the animals and the human biological information of the each of the people which are measured in the measuring, and presenting the recommendation information to the each of the people, the recommendation information being generated to improve the health condition of the each of the animals and the health condition of the each of the people.

5. The health management method according to claim 4, further comprising
calculating an activity amount of the each of the animals from the biological information of the each of the animals as measured in the measuring, and calculating an activity amount of the each of the people from the biological information of the each of the people as measured in the measuring,
wherein, in the generating of the recommendation information, a walking route is generated as the recommendation information and presented to the each of the people, the walking route having a distance corresponding to the activity amount of the each of the animals and the activity amount of the each of the people.

6. The health management method according to claim 4,
wherein the measuring further includes measuring, by the corresponding animal measurement terminal, a position of the each of the animals at a time of the measuring of the biological information of the each of the animals, thereby generating position information indicating the position,
the obtaining further includes obtaining the position information indicating the position of the each of the animals as generated in the measuring,
the health management method further comprises
determining, based on the biological information of the each of the animals as measured in the measuring, whether or not the each of the animals is happy at the position indicated in the position information, and
in the generating of the recommendation information, when it is determined that the each of the animals is happy at the position, a walking route including the position is generated based on the position information and presented as the recommendation information to the each of the people.

7. The health management method according to claim 3,
wherein, in the generating of the human health information, pieces of the human health information are classified into a plurality of items according to at least one of an age and a sex of the people, and
in the comparing, a piece of the human health information classified into an item corresponding to the each of the people among the items is compared to the human biological information of the each of the people as measured in the measuring, thereby assessing the health condition of the each of the people.

8. The health management method according to claim 1,
wherein, in the generating of the animal health information, pieces of the animal health information are classified into a plurality of items according to at least one of a breed, an age, and a sex of the animals, and
in the comparing, a piece of the animal health information classified into an item corresponding to the each of the animals among the items is compared to the animal biological information of the each of the animals as measured in the measuring, thereby assessing the health condition of the each of the animals.
